(19) United States
(12) Patent Application Publication
(10) Pub. No.: US 2018/0170799 A1
(43) Pub. Date: Jun. 21, 2018

(54) SELF-CLEANING COATING COMPOSITION

(71) Applicant: Dyrup A/S, Soborg (DK)

(72) Inventors: Soren Hillebrandt Poulsen, Roskilde (DK); Sverrir Grimur Gunnarsson, Copenhagen K (DK); Per Moller, Graested (DK)

(21) Appl. No.: 15/898,313

(22) Filed: Feb. 16, 2018

Related U.S. Application Data
(63) Continuation of application No. 13/140,088, filed on Jan. 31, 2012, now abandoned.
(60) Provisional application No. 61/122,870, filed on Dec. 16, 2008.

(51) Int. Cl. C03C 11/00; C09D 5/16; C09D 7/40; C09C 3/06; C09C 1/30; C09D 7/62; C03C 12/02; C03C 17/25; C08K 9/02; B01J 21/08; B01J 37/02; B01J 35/08; C08K 7/28; B01J 35/00

(52) U.S. Cl. CPC C03C 11/002; B01J 35/004; C09D 7/69; C09D 5/16; C09C 3/063; C09C 1/30; C09D 5/1606; C09D 7/68; C09D 7/62; C03C 12/02; C03C 17/256; C03C 2217/212; C08K 9/02; B01J 21/08; C01P 2004/34; C01P 2004/32; C01P 2004/03; C01P 2002/72; B01J 37/0221; B01J 37/0219; B01J 37/0215; B01J 37/0209; B01J 35/08; C03C 2217/71; C03C 2218/111; C03C 2218/113; C08K 7/28; C09D 5/1687

(57) ABSTRACT

The present invention relates to compositions with self-cleaning properties. More particularly, the invention concerns coatings or paints comprising particles coated with a catalytically active composition. In particular, a self-cleaning coating composition (paint) is provided, comprising micro-sized particles coated with a functional layer, wherein the micro-sized particles are hollow or solid beads, or any combination/ratio of hollow and solid beads, wherein the beads comprise one or more material(s) selected from ceramic material(s); polymeric material(s); cermet material(s); metallic material(s); pigmented material(s); light-absorbing and/or light reflecting material(s); including any combination thereof, wherein said layer is covalently bound to said particles, wherein the photocatalytic layer comprises TiO₂ in the crystal form of anatase; and wherein the coating composition (paint) comprises less than 0.1 anatase particles derived/released from the micro-sized beads, determined as weight/weight of released anatase/total amount of anatase. The invention provides paint essentially without presence of unbound anatase crystals which is highly undesired, as it is believed that their presence has a negative influence on essential components of the paint, such as binder, pigment and/or additives and furthermore, anatase may cause eye, skin, and respiratory tract irritation.

### TECHNICAL FIELD OF THE INVENTION

The present invention relates to compositions with self-cleaning properties. More particularly, the invention concerns coatings or paints comprising particles coated with a catalytically active composition.

### BACKGROUND OF THE INVENTION

There is a need in the art for compositions related to coatings or paints providing self-cleaning properties. Such properties can e.g. be mediated by electromagnetic radiation, such as sunlight, for example by the use of heterogeneous photocatalysis, a process in which a solid catalyst semiconductor both absorbs light and acts as a catalyst. Such a process can e.g. be utilized to oxidize organic compounds and has been used for applications such as cleaning water. It is believed that when a photocatalytic semiconductor is exposed to light with sufficiently short wavelength (i.e. sufficiently high energy) to promote an electron from the valence band to the conduction band of the photocatalyst, which depends on the band gap of the photocatalyst, a positive “hole” is created. The electron and the positive hole can diffuse to the surface where the electron generally reduces oxygen and the hole oxidizes adsorbed molecules for example water or some organic material. If an absorbed water molecule is oxidized an OH radical, which has an extremely high oxidation potential, is formed and can then further oxidize an organic molecule.

This effect is well known and has been utilized in self cleaning products such as Pilkington Activ™ window glass and in some types of paints, such as silicone paints. Silicone binders are believed to be resistant to the photocatalytic effect because a protective layer of SiO₂ is formed when the binder is oxidized, but they are relatively expensive compared to other organic binders. Silicone based paints appear only suitable for a limited range of applications. For wood these paints will be too open for water vapor transmission and in many instances not flexible enough which may result in cracking and flaking.

Commonly, an organic binder will not form a protective layer when oxidized and therefore organic binders are not as resistant. Environmental effects and/or weathering will cause the film to decompose making the film chalk, i.e. pigment particles loose adhesion to the film due to binder decomposition. Therefore photocatalytic activity in paint comprising organic binders is considered undesirable, so photocatalytic pigments such as TiO₂ are generally coated with other oxides such as Al₂O₃ and/or SiO₂ to reduce the photocatalytic activity of TiO₂ in order to reduce chalking of the paint film.

The chalking effect is used in some cases to make paint films self cleaning. That means that the chalking rate of the paint film is controlled by adding nano-sized photocatalytic particles into the film so the surface will constantly renew itself because the film constantly erodes. However, this solution does not provide a durable film and also introduces another potentially more serious problem, namely a high release of photocatalytic nano-particles to the environment. The photo-toxicological effect of highly photocatalytic material is believed to be very dangerous, especially if photocatalytic particles come into contact with e.g. the skin. If photocatalytic particles are in contact with skin and exposed to sunlight, or any UV-radiation source for that matter, the extremely powerful oxidation process will attack skin cells. This can be especially dangerous if the size of the photocatalytic particles is in the nano range because they can easily diffuse through the top skin layers and reach healthy living cells. Photocatalytic nano-particles are believed to be a possible carcinogenic. Therefore it is necessary to develop a technology where photocatalytic material is used to give organic coatings self cleaning properties without causing the film to chalk too fast and release nano-sized particles to the environment.

It is an objective of the present invention, to provide a self-cleaning paint which addresses one or more of the above-mentioned issues.

U.S. Pat. No. 6,110,528 concerns a method for the preparation of fine hollow glass spheres coated with TiO₂ in which volcanic vitreous deposit sand is dispersed in an aqueous solution containing hydrogen chloride containing TiCl₄ or in an aqueous solution of sulphuric acid containing Ti(SO₄)₂. Due to the high reactivity of these titanium precursors with water it is believed that all of the precursor will have reacted with water before the vitreous deposit sand is dispersed in the solution, and after all of the precursor has already reacted with water, the titanium precursor cannot react with OH groups on the vitreous deposit sand surface and thereby form a covalent bond. U.S. Pat. No. 6,110,528 mentions that hydrous titanium oxide is formed. In an alternative coating method the sand is dispersed in a solution of alcohol containing a titanium tetra-alkoxide where the hydrolysis is performed after dispersing the vitreous deposit sand in the solution. There is no indication of initial removal of physically adsorbed water from the sand surface before coating.

In JP 2005-199261 is disclosed a similar method for coating glass beads which is to disperse the particles in a solution of isopropyl alcohol containing a titanium sol. There is no indication of initial removal of physically adsorbed water from the bead surface before the coating.

WO 2008/142205 discloses coating of particles by high energy mechanical mixing TiO₂ particles with ground granulated blast furnace slag and cement. There is no indication of any bonding mechanism between the photocatalytic material and the carrier particle material or of any initial removal of physically adsorbed water from the bead surface before the coating.

U.S. Pat. No. 5,616,532 concerns a photocatalyst composition containing a substantially non-oxidizable binder.

WO 2004/060555 pertains to a photocatalytically-active, self-cleaning coating compositions and methods.

Srinivasan et al. (1994) relates to the interaction of titanium isopropoxide with surface hydroxyls on silica.

Linsebigler et al. (1995) relates to the principles and mechanisms of photocatalysis on TiO₂ surfaces.

Lachheb et al. (2002) relates to photocatalytic degradation of various types of dyes including methylene blue.

Portjanskaja et al. (2004) relates to photocatalytic oxidation of humic substances with TiO₂-coated glass micro-spheres.

Hair (1975) relates to hydroxyl groups on a silica surface and adsorption of water molecules on silica surface.

It is an object of the invention to provide self-cleaning paint comprising photocatalytically active titanium dioxide, bound to carrier particles, in the form of anatase essentially without presence of unbound anatase crystals.

### SUMMARY OF THE INVENTION

In a first aspect, the invention relates to a self-cleaning coating composition and/or self cleaning paint comprising micro-sized particles coated with a functional layer, wherein the micro-sized particles are hollow or solid beads, or any combination/ratio of hollow and solid beads, wherein the beads comprise one or more material(s) selected from ceramic material(s); polymeric material(s); cermet material(s); metallic material(s); pigmented material(s); light-absorbing and/or light reflecting material(s); including any combination thereof, wherein said layer is covalently bound to said particles, wherein the photocatalytic layer comprises TiO₂ in the crystal form of rutile and/or anatase; and wherein the coating composition (paint) comprises less than 1%; 0.1%; 0.01%; 0.001%; 0.0001%; or 0.00001% anatase particles derived/released from the micro-sized beads, determined as weight/weight of released anatase/total amount of anatase.

According to a preferred embodiment of the invention the functional layer is a photocatalytic layer.

A second aspect of the invention concerns a self-cleaning surface comprising a dried layer (paint film) derived from a self-cleaning paint, such as a paint comprising micro-sized particles coated with a functional layer, wherein the micro-sized particles are hollow or solid beads, or any combination/ratio of hollow and solid beads, wherein the beads comprise one or more material(s) selected from ceramic material(s); polymeric material(s); cermet material(s); metallic material(s); pigmented material(s); light-absorbing and/or light reflecting material(s); including any combination thereof, wherein the photocatalytic layer comprises TiO₂ in the crystal form of rutile and/or anatase; and wherein said layer is covalently bound to said particles, wherein the coating composition (paint) comprises less than 1%; 0.1%; 0.01%; 0.001%; 0.0001%; or 0.00001% anatase particles derived/released from the micro-sized beads, determined as weight/weight of released anatase/total amount of anatase.

A third aspect of the invention pertains to a method of cleaning a surface according to the invention, comprising the step of exposing said self-cleaning surface to electromagnetic radiation, wherein said electromagnetic radiation comprises radiation with a wavelength in the range of 200-400 nm and/or 400-800 nm, wherein said radiation is provided by the sun (e.g. daylight, reflected sunlight, twilight, moonlight), or by an artificial source.

A fourth aspect of the invention relates to a use of a self-cleaning coating composition (paint) comprising micro-sized particles coated with a functional layer, wherein the micro-sized particles are hollow or solid beads, or any combination/ratio of hollow and solid beads, wherein the beads comprise one or more material(s) selected from ceramic material(s); polymeric material(s); cermet material(s); metallic material(s); pigmented material(s); light-absorbing and/or light reflecting material(s); including any combination thereof, wherein said layer is covalently bound to said particles, wherein the photocatalytic layer comprises TiO₂ in the crystal form of rutile and/or anatase; and wherein the coating composition (paint) comprises less than 1%; 0.1%; 0.01%; 0.001%; 0.0001%; or 0.00001% anatase particles derived/released from the micro-sized beads, determined as weight/weight of released anatase/total amount of anatase for providing a self-cleaning surface on wood, brick, concrete, cement, asphalt, natural or artificial stone, clay, glass, plastic, metal, fiber glass, carbon fibers, (wall) paper, painted surface, glued surface, composite material, or any combination thereof, such as a surface on an item, wall, building, structural element, bridge, building element, building block, window, door, floor, ceiling, roof (sheathing), smoothed and/or plastered surface, furniture, house hold equipment, medical equipment, sanitary equipment, car, (motor)bike, truck, container, bus, aircraft, rocket, ship, train, locomotive, wind mill, or solar panel.

A fifth aspect of the invention concerns one or more micro-sized particles coated with a functional layer, wherein the micro-sized particles are hollow or solid beads, or any combination/ratio of hollow and solid beads, wherein the beads comprise one or more material(s) selected from ceramic material(s); polymeric material(s); cermet material(s); metallic material(s); pigmented material(s); light-absorbing and/or light reflecting material(s); including any combination thereof, wherein the functional layer comprises TiO₂ in the crystal form of rutile and/or anatase and the layer is covalently bound to the particles.

A sixth aspect of the invention relates to a method for providing one or more micro-sized particles coated with a functional layer, wherein the micro-sized particles are hollow or solid beads, or any combination/ratio of hollow and solid beads, wherein the beads comprise one or more material(s) selected from ceramic material(s); polymeric material(s); cermet material(s); metallic material(s); pigmented material(s); light-absorbing and/or light reflecting material(s); including any combination thereof, wherein the functional layer comprises TiO₂ in the crystal form of rutile and/or anatase and the layer is covalently bound to the particles,

which method comprises the steps of:
1. pre-treating micro-sized particles by heating to a temperature of 110-200° C. to evaporate physically adsorbed water from the surface.
2. evaporating titanium precursor by applying heat and/or vacuum.
3. carrying the evaporated titanium precursor in an inert gas, e.g. nitrogen or argon, with less than 10 ppm H₂O into a reaction chamber, where the micro-sized particles are continuously being stirred, e.g. mechanically or fluidized by the carrier gas, wherein the temperature in the reaction chamber can be in the range −20-800° C.
4. mixing inert gas having 0.01-50% relative humidity with the micro-sized particles to hydrate the surface while stirring or fluidizing, and
5. heating the coated micro-sized particles to a temperature in the range 100-800° C. for a period ranging from a few seconds to several hours to crystallize the anatase.

Steps 2, 3 and 4 may be repeated to build up a thicker coating layer, if desired, before advancing to step 5.

In has been found that if physically adsorbed water is not removed from the particle surface the titanium precursor, it will hydrolyze before it can come into contact with the particle surface. If however physically adsorbed water is removed the titanium precursor will react with the particle surface. The precursor reacts with OH groups on the particle surface, which hydrolyze the precursor, forming a covalent bond between the titanium atom and the micro-sized particle as shown in FIG. 2.

### BRIEF DESCRIPTION OF THE DRAWINGS

FIG. 1 shows a schematic representation of a cross section of a surface painted/coated with a paint comprising beads coated with photocatalytic material. (A) Shortly after application to surface; (B) after considerable wear and/or weathering; (C) after severe wear and/or weathering.

(1) Environment; (4) Interface between paint film and substrate; (5) Substrate; (10) Predominantly binder; (12) Paint film surface; (20) Active coated bead; (21) Inactive coated bead; (25) Active photocatalytic material; (26) Inactive photocatalytic material.

FIG. 2 shows a schematic representation of the reaction when a titanium precursor reacts with a glass surface and a covalent bond between the glass and titanium is formed.

FIG. 3a shows SEM images of hollow glass microspheres (HGMS) uncoated and coated with anatase TiO₂.

FIG. 3b shows SEM images of hollow glass microspheres (HGMS) coated without initial drying.

FIG. 4 shows XRD analysis of commercially available anatase powder and glass bead coating.

FIG. 5 shows a time plot of concentration change vs. irradiation time showing the decomposition of a methylene blue solution with and without TiO₂-coated HGMS.

FIG. 6 shows SEM images of alkyd paint films comprising TiO₂-coated HGMS after different exposure times in a QUV chamber.

FIG. 7 shows SEM images of alkyd paint films after different exposure times in a QUV chamber.

FIG. 8 shows SEM images of polyurethane paint films comprising TiO₂-coated HGMS after different exposure times in a QUV chamber.

FIG. 9 shows SEM images of polyurethane paint films after different exposure times in a QUV chamber.

FIG. 10 shows SEM images of polyurethane paint films comprising anatase TiO₂ nano-particles after different exposure times in a QUV chamber.

FIG. 11 shows results of a self cleaning test made with an alkyd paint film comprising TiO₂-coated HGMS and an alkyd paint film comprising uncoated HGMS.

FIG. 12 shows a plot of irradiance vs. wavelength of UVA-340 lamps.

### DEFINITIONS

In the context of the present invention, the following definitions may apply to the terms listed below, unless specified otherwise:

The terms “titanium dioxide”, “TiO₂” and/or “TiO2” are meant to comprise oxides of titanium, and can be used interchangeably. Titanium dioxide can also comprise different crystal forms known in the art, such as anatase, rutile, brookite, and the like, including any mixtures between one or more crystal forms. Alternatively, titanium dioxide can also be present in one or more amorphous forms (i.e. non-crystalline form), including any mixture between said one or more amorphous forms. Furthermore titanium dioxide can be present in any mixture between one or more amorphous forms, and one or more crystalline forms.

Unless specified otherwise, chemical compositions are either p.a. (pro analysii), in pure form (i.e. usually more than 99% or 99.9% (weight/weight or volume/volume (vol./vol.) purity), almost pure form (i.e. usually more than 90% or 95% (weight/weight or vol./vol.) purity), or in technically pure form, such as a purity, which is common, generally known and/or accepted in the art.

The terms “bead” or “particle” can be used interchangeably, and are meant to comprise a particle or piece of material/composition having virtually any three-dimensional shape, including spherical, near-spherical, rotational symmetrical, octahedral, prismatic. Bead(s) or particle(s) can also be of irregular shape, and/or of irregular cross section. The term “bead” can also be meant to comprise filler material that can be added to paint in volume concentration of e.g. 10% or more of the volume of solids of a dried paint film, without severely affecting the rheological properties of the paint.

The term “equivalent diameter” is meant to comprise the diameter of a bead, if it were a sphere with equal volume as said bead. Thus a bead, not of spherical shape, with a volume of π/6 μm³ would have an equivalent diameter of 1 μm as a sphere of equal volume.

The term “layer” is meant to comprise a film or coating of any material on a surface, thus comprising paint, coating compositions etc., but also e.g. any material deposited or associated with a particle or bead, such as photocatalytic material coated onto a bead. It can also refer as to a paint film, which can be wet, in the process of drying, or dry or dried. The latter can also be referred to as “dried layer”.

The terms “material(s)” and “composition(s)” can be used interchangeably.

The terms “polymeric” and “polymeric material/composition” can be used interchangeably and are meant to comprise material/composition which is made up of repeating subunits of organic, inorganic and/or organo-metallic materials including any combination and/or mixture thereof.

The terms “ceramic” and “ceramic material/composition” can be used interchangeably and are meant to comprise inorganic non-metallic material(s) and/or compositions which comprise e.g. oxides, nitrides, borides, carbides, silicides and sulfides including any combination and/or mixture thereof. Ceramic materials can be non-crystalline (glass or glass-like), partially crystalline, or fully crystalline.

The terms “metallic” and “metallic material/composition” can be used interchangeably and are meant to comprise metal(s) or metalloid(s) according to the periodic system of elements including alloys and intermetallics and any combination and/or mixture thereof. Metallic materials can be non-crystalline (glass), partially crystalline or fully crystalline.

The terms “cermet” and “cermet material/composition” can be used interchangeably and are meant to comprise composite material(s) comprising ceramic and metallic material as defined above. Cermet materials can be non-crystalline (glass), partially crystalline or fully crystalline.

The term “light absorbing material(s)/composition(s)” is meant to comprise material(s) and/or composition(s) that can absorb electromagnetic radiation, such as electromagnetic radiation in the range ˜300-800 nm.

The term “light reflecting material(s)/composition(s)” is meant to comprise material(s) and/or compositions that can reflect electromagnetic radiation, such as electromagnetic radiation in the range ˜300-800 nm.

The terms “photocatalyst” and “photocatalytic material(s)/composition(s)” can be used interchangeably and are meant to comprise material(s)/composition(s) that can accelerate the oxidation of organic material/composition, such as by creating electron-hole pairs when exposed to electromagnetic radiation

The term hollow glass bead is meant to comprise beads comprising a glass shell and a void under the shell comprising essentially air, gas and/or vacuum.

The terms “self cleaning”, “self cleaning surface” and “self cleaning layer” can be used interchangeably and are meant to comprise surfaces/layers that through e.g. heterogeneous photocatalysis, hydrophilicity and/or hydrophobicity are resistant dirt and/or contamination, or can prevent, remove or disintegrate organic and/or inorganic dirt/undesired material and/or micro-organisms from adhering/contaminating the surface/layer.

The term “wetting” is meant to comprise a liquids capability to wet a solid surface, where high or good wetting is represented by a low contact angle between liquid and solid, and low or poor wetting represented by a high contact angle.

The term “abrasion resistance” is meant to comprise resistance to mechanical wear.

The term “weather resistance” is meant to comprise resistance to environmental factors, such as weather, sunlight, UV radiation, rain, moisture, temperature and wind.

The term “chalking” is meant to comprise a process, where the binder in the surface of a paint film is degraded, often as a result of weathering, causing pigment particles to become loose.

The term “co-catalyst” is meant to comprise a catalyst that can accelerate e.g. oxidation of organic material on the surface of a photocatalyst.

The term “band gap” is meant to comprise the energy difference between the bottom of the conduction band and the top of the valence band of a material/composition.

The term “BET surface area” is meant to comprise the measured surface area of particles according to the BET (Brunauer-Emmet-Teller) adsorption theory.

The term “crystal size” is meant to comprise the measured crystal size of material/composition/particle using e.g. the method of powder diffraction and calculated with the Debye-Scherrer formula and/or the Stokes and Wilson expression.

The term “index of refraction” is meant to comprise the index of refraction measured at the sodium D-line at approximately 589 nm. When the term is used e.g. for hollow beads, it can be used to only refer to the shell material and not the air, gas and/or vacuum inside the hollow space.

The terms “nano-particle(s)” and “nano-sized particle(s)” can be used interchangeably and are meant to comprise particles that have a diameter and/or equivalent diameter around or below 1 μm, often in the range of around 1-1000 nm.

The terms “micro-particle(s)” and “micro-sized particle(s)” can be used interchangeably and are meant to comprise particles that have a diameter and/or equivalent diameter around or below 1 mm, often in the range of around 1-1000 μm.

The terms “coating”, “coating composition”, “paint”, and/or “paint composition” can be used interchangeably, and are meant to comprise any fluid, liquid, gel, powder, liquefiable, or mastic composition—which after application to a substrate or surface in a layer of a certain thickness—is converted to an essentially solid, or semi-solid film. Commonly, paint is liquid during application and comprises one or more of:
pigment,
binder (also called resin),
solvent (also called vehicle), and
filler.

Optionally, a paint can comprise one or more additives.

The terms “pigment” and “pigmented material(s)/composition(s)” can be used interchangeably and are meant to comprise material(s)/composition(s) with light absorption properties, comprising electromagnetic radiation with wavelengths in the range of visible light, such as ˜380-750 nm, optionally altered by the addition of another material/materials such as one or more pigment(s). Pigments are suitably granular solids incorporated into the paint to contribute color and opacity. Furthermore they may, e.g. for wood stains, contribute to UV-protection. Alternatively, some paints contain dyes instead of or in combination with pigments. Other paints contain no pigment at all. Pigments can be classified as either inorganic or organic pigments. Inorganic pigments include e.g. titanium dioxide, carbon black or red and yellow iron oxides. The group of organic pigments comprises synthesized and/or modified organic compounds with chromatic properties, e.g. phthalo blue, phtalo green and chinacridone. A pigment according to the invention may also comprise one or more pigments disclosed in Industrial Inorganic Pigments, 3rd, Completely Revised and Extended Edition, Gunter Buxbaum and Gerhard Pfaff (Editors), ISBN: 978-3-527-30363-2 (2005); and/or Industrial Organic Pigments: Production, Properties, Applications, 3rd, Completely Revised Edition, Willy Herbst, Klaus Hunger, ISBN: 978-3-527-30576-6 (2004); the subject matter of these references is hereby incorporated by reference.

The term “filler” is meant to comprise any material, matter, component and/or composition added to thicken the film, support its structure and simply increase the volume of the paint and/or to lower the cost. Fillers are usually comprised of cheap and inert materials, such as on or more of talc, calcium carbonate, kaolin, lime, baryte, clay, etc. Paints that will be subjected to abrasion may even contain fine quartz sand as filler. Not all paints include fillers. On the other hand some paints contain large proportions (more than e.g. 10, 20, 30, 40 or 50% (vol/vol) of filler.

The terms “binder” or “resin” are meant to comprise the actual film forming component of paint. The binder imparts adhesion, binds the pigments together, and strongly influences such properties as gloss potential, exterior durability, flexibility, and toughness. Binders include synthetic or natural resins such as acrylics, polyurethanes, polyesters, melamine resins, epoxy, alkyds, modifications of these or oils. Binders can be categorized according to drying, or curing mechanism used commonly for paints. Common principles are solvent evaporation, oxidative cross-linking, (catalyzed) polymerization, and coalescence. The term organic binder relates to organic polymeric material.

The term “solvent” and/or “vehicle” is meant to comprise a composition, agent, fluid and the like, suitable to act as a carrier for non volatile components. The solvent/vehicle can also be used to e.g. to adjust the viscosity of the paint. It can also control flow and application properties, and affect the stability of the paint while in liquid state. Its main function is as the carrier for the non volatile components. Solvents are generally more or less volatile. Water is the main vehicle for water based paints. Organic solvent-based, also called oil-based paints can consist of one or more solvents, such as one or more of aliphatic solvents, aromatic solvents, alcohol, ketones, petroleum distillates, esters, and glycol ethers, and the like. Optionally, paints can comprise a volatile low-molecular weight synthetic resins also serve as diluents.

The term “additive(s)” is meant to comprise a component, agent, composition and the like usually added in smaller amounts (e.g. less than 5%, 1%, 0.1%, or 0.01% (vol./vol.) and yet give a very significant effect on the product. Additives can comprise one or more of catalysts, thickeners, stabilizers, emulsifiers, texturizers, adhesion promoters, UV stabilizers, flatteners (de-glossing agents), biocides to fight microbial and/or plant growth, agents to modify and/or control surface tension, agents to improve and/or control flow properties such as thixotropic agents, agents to improve the finished appearance, agents to increase wet edge, agents to improve pigment stability, agents to impart anti-freeze properties, agents to control foaming, agents to control skinning, agents to catalyze drying. Often, a paint and/or coating composition comprises one or more additives.

### Drying and Curing

Drying and curing can be regarded as two different processes. Drying generally refers to evaporation of vehicle, whereas curing refers to polymerization of the binder. The result of the drying and/or curing of the paint can be a dried layer or paint film. Depending on chemistry and composition of the paint, any particular paint may undergo either drying or curing or both processes. Thus, there are paints that dry only, those that dry then cure, and those that do not depend on drying for curing. Paints that dry by simple solvent evaporation usually contain a solid binder dissolved in a solvent; this forms a solid film when the solvent evaporates, and the film can re-dissolve in the solvent again. Classic nitrocellulose lacquers fall into this category, as do non-grain raising stains composed of dyes dissolved in solvent. Latex paint is a water-based dispersion of sub-micrometer (μm) polymer particles. The term “latex” in the context of paint simply means an aqueous dispersion; latex rubber (the sap of the rubber tree that has historically been called latex) is usually not a paint ingredient. These aqueous dispersions are prepared by emulsion polymerization. Latex paints cure by a process called coalescence where first the water, and then the trace, or coalescing, solvent, evaporate and draw together and soften the latex binder particles together and fuse them together into irreversibly bound networked structures, so that the paint will not re-dissolve in the solvent/water that originally carried it. Residual surfactants in the paint as well as hydrolytic effects with some polymers can cause the paint to remain susceptible to softening and, over time, degradation by water.

Paints that cure by oxidative cross-linking are generally single package coatings that when applied, the exposure to oxygen in the air starts a process that crosslinks and polymerizes the binder component. Classic alkyd enamels would fall into this category.

Paints that cure by catalyzed polymerization are generally two package coatings that polymerize by way of a chemical reaction initiated by mixing resin and hardener, and which cure by forming a hard plastic-like structure. Depending on composition they may need to dry first, by evaporation of solvent. Examples of paints that cure by catalyzed polymerization include epoxy- and polyurethane paints.

Still other films are formed by cooling of the binder. For example, encaustic or wax paints are liquid when warm, and harden upon cooling. Often, they can re-soften and/or liquefy if reheated.

Environmental requirements can restrict the use of volatile organic compounds, and alternative means of curing have been developed, particularly for industrial purposes. In UV-curing paints, the solvent is evaporated first, and hardening is then initiated by ultraviolet light. In powder coatings there is little or no solvent, and flow (film) and cure are produced by heating of the substrate after application of the dry powder.

Apart from the definitions given herein, further definitions concerning the present invention may apply, such as definitions provided in e.g. “Coatings Formulation”, Bodo Muller and Ulrich Poth, 2006, Vincentz Network; “Organic Coatings: Science and Technology”, 3rd Ed., Zeno W. Wicks, Jr., Frank N. Jones, S. Peter Pappas, and Douglas A. Wicks, 2007, Wiley—Interscience; and “BASF Handbook on Basics of Coating Technology”, Artur Goldschmidt and Hans-Joachim Streitberger, 2003, Vincentz Network; the subject matter of said references is hereby incorporated by reference.

### DETAILED DESCRIPTION OF THE INVENTION

### Self-Cleaning Coating Composition

In a first aspect of the present invention, a self-cleaning coating composition (“paint”) is provided, such as a self-cleaning paint and/or a paint providing a self-cleaning surface. A suitable self-cleaning coating composition may comprise one or more micro-sized particles (“particles”) coated with a functional layer.

In a first aspect the invention relates to a self-cleaning coating composition (paint) comprising micro-sized particles coated with a functional layer, wherein the micro-sized particles are hollow or solid beads, or any combination/ratio of hollow and solid beads, wherein the beads comprise one or more material(s) selected from ceramic material(s); polymeric material(s); cermet material(s); metallic material(s); pigmented material(s); light-absorbing and/or light reflecting material(s); including any combination thereof, wherein the photocatalytic layer comprises TiO₂ in the crystal form of rutile and/or anatase; and wherein the coating composition (paint) comprises less than 1%; 0.1%; 0.01%; 0.001%; 0.0001%; or 0.00001% anatase particles derived/released from the micro-sized beads, determined as weight/weight of released anatase/total amount of anatase.

According to a preferred embodiment of the invention the photocatalytic material is covalently bonded to the beads.

The presence of unbound anatase crystals in the paint is not desired, as it is believed that their presence has a negative influence on essential components of the paint, such as binder, pigment and/or additives and furthermore, anatase may cause eye, skin, and respiratory tract irritation.

According to the invention, the self-cleaning paint comprises less than 1%; 0.5%; 0.25%; 0.1%; 0.05%; 0.025%; 0.01%; 0.005%; 0.0025%; 0.001%; 0.0005%; 0.00025%; 0.0001%; 0.00005%; 0.000025%; or even less than 0.00001% anatase particles derived/released from the micro-sized beads, determined e.g. as weight/weight of released anatase per total amount of anatase.

It is preferred that a self-cleaning paint according to the invention comprises less than 0.1% free anatase.

According to an embodiment of the invention, a coating and/or coating composition is provided according to “Coatings Formulation”, Bodo Muller and Ulrich Poth, 2006, Vincentz Network; “Organic Coatings: Science and Technology”, 3rd Ed., Zeno W. Wicks, Jr., Frank N. Jones, S. Peter Pappas, and Douglas A. Wicks, 2007, Wiley—Interscience; and “BASF Handbook on Basics of Coating Technology”, Artur Goldschmidt and Hans-Joachim Streitberger, 2003, Vincentz Network, further comprising a micro-sized particles (“particles”) coated with a functional layer, such as any particle(s) coated with a functional layer according to the present invention.

According to an embodiment, the paint comprises one type of micro-sized particles, or two or more types of micro-sized particles, optionally coated with a similar or different functional layer.

According to an embodiment of the invention, the paint comprises micro-sized particles, such as hollow, partially-hollow; or solid beads, or any combination/ratio thereof, such of hollow, partially hollow, and solid beads.

According to an embodiment of the invention, the paint comprises beads comprising one or more material(s) selected from e.g. ceramic material(s); polymeric material(s); cermet material(s); metallic material(s); pigmented material(s); light-absorbing and/or light reflecting material(s) etc.; including any combination thereof.

It is believed that the size of the beads used may be related to the desired thickness of a dry paint film, and is preferably less than the film thickness. According to an embodiment of the invention, the particles/beads should also not be too small, as the ratio of area of contact between photocatalytic coating and binder vs. volume of beads increases as the beads become smaller.

According to an embodiment of the invention, more than 10, 20, 30, 40, 50, 60, 70, 80, 85, 90, 92.5, 95, 97, 98, 99, 99.5, 99.9, 99.95, or 99.99% of the micro-sized particles of one or more type(s) have an equivalent diameter in the range of around 0.1-2000 μm, 1-1000 μm, 1-900 μm, 1-800 μm, 1-700 μm, 1-600 μm, 1-500 μm, 1-400 μm, 1-300 μm, 1-200 μm, 1-100 μm, 0.5-20 μm, 2-1000 μm, 2-900 μm, 2-800 μm, 2-700 μm, 2-600 μm, 2-500 μm, 2-400 μm, 2-300 μm, 2-200 μm, 1-100 μm, 5-1000 μm, 5-900 μm, 5-800 μm, 5-700 μm, 5-600 μm, 5-500 μm, 5-400 μm, 5-300 μm, 5-200 μm, 5-100 μm, 10-1000 μm, 10-900 μm, 10-800 μm, 10-700 μm, 10-600 μm, 10-500 μm, 10-400 μm, 10-300 μm, 10-200 μm; 10-100 μm, or 10-200 μm.

Preferably more than 95% of the particles have an equivalent diameter in the range of 0.5-20 μm. In one embodiment of the invention the particles are hollow glass beads, such as hollow glass micro spheres (HGMS).

When the paint comprises more than one type of micro-sized particles, these may be identical, similar, or different in size and/or equivalent diameter.

The size and/or density of beads can be normally distributed or the size distribution and/or the density distribution of the beads can be asymmetrical around the mean. The term percentile can be meant to comprise the size and/or density which a certain percent, “the percentile”, of measured beads of a sample are equal to or lower. For example, if the 10th percentile is 1 μm and/or 0.1 g/cm³, it means that 10% of the measured sample are 1 μm or smaller in size and/or 0.1 g/cm³, or less dense.

According to an embodiment of the invention, the mean size and/or density of the beads can be between the 40th percentile and the 60th percentile, the 30th percentile and the 70th percentile, or the 20th percentile and the 80th percentile. The 10th percentile value of bead size and/or bead density can be between 30%-70%, 20%-80% or 10%-90% of the mean bead size and/or bead density. The 50th percentile value of bead size and/or bead density can be between 70%-130%, 60%-140% or 50%-150% of the mean bead size and/or bead density. The 90th percentile value of bead size and/or bead density can be between 130%-170%, 120%-180% or 110%-190% of the mean bead size and/or bead density.

According to an embodiment of the invention, the size distribution and/or the density distribution of the beads can be so small that the size difference and/or density difference between the 10th percentile bead size and/or bead density and the mean bead size and/or mean bead density is less than 10% and/or the size difference and/or density difference between the 90th percentile bead size and/or bead density and the mean bead size and/or mean bead density is less than 10% of the mean bead size and/or mean bead density.

According to an embodiment of the invention, the paint comprises one, two, three, four, five, or more than five types of micro-sized particles.

According to an embodiment of the invention, the paint comprises micro-sized particles which are hollow glass beads, such as hollow glass micro spheres (HGMS).

According to an embodiment of the invention, the self-cleaning paint comprises beads or particles coated with a photocatalytic layer providing photocatalytic activity, said layer and/or photocatalytic activity providing e.g. one or more of:
a. reduction in growth of (micro)organisms, such as one or more of: bacteria, algae, lichen, yeasts and/or moulds; and/or
b. increase in adhesion strength between an organic binder and a bead by chemical bonding; and/or
c. increase in abrasion resistance of the paint film; and/or
d. increase in weather resistance and/or UV-stability, such as one or more of (i) reduction of chalking of an organic binder; (ii) reduction of decomposition of an organic binder; and/or (iii) reduction of release of (photocatalytic) material and/or material with a particle size of less than 1 μm; and/or
e. decomposition and/or oxidation of undesired organic matter and/or dirt; and/or
f. improvement of wetting property of the paint; and/or
g. any combination of a-g.

The coating can also be designed to have various other properties depending on what is needed for a given paint system. Without wanted to be bound by any theory, according to an embodiment of the invention an improved adhesion between the beads and the binder is achieved and/or provided.

This improved adhesion could e.g. be achieved by creating covalent bonds between the coated beads and the binder or due to high affinity of the binder to the coated beads. This is believed to improve the mechanical properties of the paint film, making it more resistant to cracking.

According to an embodiment of the invention, the self-cleaning paint comprises a layer, such as a photocatalytic layer, wherein said layer comprises e.g. one or more of:
a. a photocatalyst and/or n-type semiconductor having a band gap in the range of 1.8-10.3, 2.5-6.2 or 3.1-4.1 eV, preferably 3.1-4.1 eV; and/or
b. a photoconductive material/composition; and/or
c. a photocatalytic material/composition; optionally comprising one or more catalyst(s) selected e.g. from the group consisting of: TiO₂, ZnO, WO₃, SnO₂, CaTiO3, Bi₂S₃, Cu₂O, Fe₂O₃, ZrO₂, SiC and TiₓZr₍₁₋ₓ₎O₂ (0<x<1), and any combination thereof; optionally doped with one or more co-catalyst(s), wherein the co-catalyst is selected e.g. from the group consisting of palladium, platinum, rhodium, ruthenium, tungsten, molybdenum, gold, silver, copper, including any of their oxides and/or any of their sulfides, and any combination/mixture/ratio of two or more of palladium, platinum, rhodium, ruthenium, tungsten, molybdenum, gold, silver, copper, including any of their oxides and/or any of their sulfides; wherein the molar ratio of co-catalyst(s) to catalyst is optionally less than 1 ppm, 1 ppm—0.1%; 0.1-1%, 1-10%, or more than 10%; and/or wherein said co-catalyst covers optionally less than 10%, 5%, or 1% of the surface area of the photocatalytic layer; and/or wherein said co-catalyst covers optionally between 0.001-3%, or 0.01-2%, preferably 0.001-3% of the surface area of the photocatalytic layer; and/or
d. any combination of a.-c.

According to an embodiment of the invention, the self-cleaning paint comprises micro-sized particles comprising a photocatalytic layer comprising a photocatalyst and/or n-type semiconductor, wherein the photocatalyst and/or n-type semiconductor has a band gap in the range 1.8-6.2 eV (˜200-700 nm), ˜3.1-10.3 eV (˜120-400 nm), ˜3.1-6.2 eV (˜200-400 nm), ˜2.5-4.1 eV (˜300-500 nm), ˜1.8-4.1 eV (˜300-700 nm), less than 1.8 eV (˜>700 nm) or more than 6.2 eV (˜<120 nm). Said photocatalyst and/or n-type semiconductor can be doped with e.g. one or more of N-, S-, and F-atoms, including any combination and/or ratio thereof.

According to an embodiment of the invention, a photocatalytic layer comprising a photocatalyst and/or n-type semiconductor is provided, wherein the photocatalyst and/or n-type semiconductor has a band gap of around 1.8-6.2 eV (˜200-700 nm), ˜3.1-10.3 eV (˜120-400 nm), ˜3.1-6.2 eV (˜200-400 nm), ˜2.5-4.1 eV (˜300-500 nm), ˜1.8-4.1 eV (˜300-700 nm), less than 1.8 eV (˜>700 nm) or more than 6.2 eV (˜<120 nm). According to a further embodiment, the band gap is between ˜1.8-2.5 eV, 2.5-3.1 eV, 3.1-4.1 eV, 4.1-6.2 eV, or ˜6.2-10.3 eV. The radiation is preferably with a wavelength in the range of 200-400 nm. In yet a further embodiment, the band gap is ˜3.2 eV (˜388 nm). If the radiation is provided by visible light, the wavelength will be in the range 400-800 nm.

According to an embodiment of the invention, the self-cleaning paint comprises micro-sized particles comprising a photocatalytic layer, wherein:

(i) the photocatalytic material is covalently bound to said beads/micro-sized particles; and/or
(ii) the photocatalytic material coated on the beads/micro-sized particles has a crystal size of 1-150 nm; and/or
(iii) the photocatalytic material coated on the beads optionally has a specific surface area (e.g. BET surface area) in the range of 0.01-100; 0.1-100, 1-100, 10-100, 0.01-50, 0.1-50, 1-50, 10-50, 0.01-30, 0.1-30, 1-30, 0.01-10, 0.1-10, or 1-10, preferably 0.01-100 m²/g; and/or
(iv) any combination of (i)-(iii).

In an embodiment of the invention, alternatively, the BET surface area of a bead or particle, optionally with or without coating or (photocatalytic) layer, can be less than 0.01 m²/g, or greater than 100 m²/g. Said BET surface area can also be in the range of 0.01-100; 0.1-100, 1-100, 10-100, 0.01-50, 0.1-50, 1-50, 10-50, 0.01-30, 0.1-30, 1-30, 0.01-10, 0.1-10, or 1-10 m²/g.

According to an embodiment of the invention, the weight of the bound photocatalyst in average is more than 0.001%; 0.0025%; 0.005%; 0.01%; 0.025%; 0.05%; 0.1%; 025%; 0.5%; 1%; 2.5%; 5%; or 10% of the weight of the bead.

According to an embodiment of the invention, the self-cleaning paint comprises micro-sized particles comprising a photocatalytic layer, wherein more than 90%; 99%; or 99.9%, preferably more than 99% (weight/weight) of the TiO₂ in the photocatalytic layer is in the catalytic active form of anatase. According to another embodiment, said particles are glass spheres or a hollow glass sphere (e.g. HGMS) coated with TiO₂. According to a further embodiment, more than 50%; 75%; 80%; 90%; 95%; 99%; or 99.9% of said TiO₂ is in the (photo)catalytically active form of anatase. Preferably more than 99% of said TiO₂ is in the (photo)catalytically active form of anatase.

In one embodiment of the invention, the self-cleaning coating composition (paint) comprises particles, e.g. hollow glass spheres, where more than 95% of particles have diameter between 10 and 200 μm. In a further embodiment, essentially all particles, or more than 99%, 95%, or 90% of the particles have a diameter of less than 10 μm; 25 μm; 50 μm; 100 μm; 250 μm; 500 μm; or 1000 μm; alternatively all particles, or more than 99%, 95%, or 90% of the particles have a diameter between 0.5 and 20 μm; between 10 and 25 μm; between 20 and 40 μm; between 35 and 55 μm; between 45 and 75 μm; between 70 and 105 μm; between 100 and 300 μm; between 250 and 600 μm; or between 500 and 1100 μm. In another embodiment, all particles, or more than 99%, 95%, or 90% of the particles have a diameter of more than 10 μm; 25 μm; 50 μm; 100 μm; 250 μm; 500 μm; or 1000 μm.

Preferably more than 95% of the particles have an equivalent diameter in the range of 0.5-20 μm.

According to an embodiment of the invention, the self-cleaning paint comprises micro-sized particles comprising a photocatalytic layer comprising anatase, wherein in average 10⁵-10¹⁰; and/or at least 10², 10⁵, 10¹⁰ or more individual anatase crystals are bound per bead/particle (in average); and/or wherein the weight of the bound anatase is more than 0.001%; 0.01%; 0.1%; 1%; or 10% of the weight of the particle/bead (in average). According to a further embodiment of the invention, at least 1, 10, 10², 10³, 10⁴, 10⁵, 10⁶, 10⁷, 10⁸, 10⁹, 10¹⁰, 10¹¹, 10¹², 10¹³; 10¹⁴, 10¹⁵, or more individual anatase crystals are bound per bead/particle (in average). According to another embodiment, the weight of the bound anatase is less than 0.001%, or more than 10% of the weight of the particle/bead (in average).

According to an embodiment of the invention, the TiO₂ and/or anatase crystal size associated with a photocatalytic layer is in average around 1-200 nm, 5-100 nm, 10-80 nm. According to another embodiment, said crystal size is in average less than ˜1 nm, around ˜1-10, ˜10-20, ˜20-30, ˜30-40, ˜40-50, ˜50-60, ˜60-70, ˜70-80, ˜80-90, ˜90-100, ˜100-120, ˜120-150, ˜150-175, ˜175-200, ˜200-250, or ˜250-300 nm, or more than ˜300 nm.

According to an embodiment of the invention, and photocatalytic layer is provided with a thickness (in average) of around less than ˜1 nm, ˜1-300 nm, ˜20-160 nm, or more than ˜300 nm. According to another embodiment of the invention, the average thickness of the photocatalytic layer is ˜1 nm, around ˜1-10, ˜10-20, ˜20-30, ˜30-40, ˜40-50, ˜50-60, ˜60-70, ˜70-80, ˜80-90, ˜90-100, ˜100-120, ˜120-150, ˜150-175, ˜175-200, ˜200-250, or ˜250-300 nm, or more than ˜300 nm. According to a further embodiment, the thickness of the photocatalytic layer corresponds to the average size of the TiO₂ and/or anatase crystals associated and/or bound to the particle(s) or bead(s).

TABLE 1
Typical generic examples of paint formulations.

| Type | | Basis | Solvent | Resin | Pigment | Filler | Additive |
|---|---|---|---|---|---|---|---|
| Alkyd | Paint | Organic | ~20-70 | ~10-30 | ~0-35 | ~0-50 | ~0.1-10 |
| | | Water | ~45-70 | ~1-30 | ~0-35 | ~0-50 | ~0.1-10 |
| | Wood | Organic | ~10-90 | ~5-80 | ~0-25 | ~0-20 | ~0.1-10 |
| | stain | Water | ~40-90 | ~5-40 | ~0-25 | ~0-20 | ~0.1-10 |
| Acrylic | Paint | Water | ~45-70 | ~1-30 | ~0-35 | ~0-50 | ~0.1-10 |
| | Wood | Water | ~45-90 | ~1-30 | ~0-35 | ~0-20 | ~0.1-10 |
| | stain | | | | | | |
| Poly- | Paint | Water | ~45-70 | ~1-30 | ~0-35 | ~0-50 | ~0.1-10 |
| urethane | | | | | | | |

Compositions are given % (weight/weight)

According to an embodiment of the invention, the self-cleaning paint can be essentially an alkyd-, acryl-, polyurethane-, epoxy-, and/or co-polymer-based paint or painting composition. Typical (generic) examples of paint formulations are given e.g. in Table 1. Further examples can be found in e.g. in one or more of “Coatings Formulation”, Bodo Muller and Ulrich Poth, 2006, Vincentz Network; “Organic Coatings: Science and Technology”, 3rd Ed., Zeno W. Wicks, Jr., Frank N. Jones, S. Peter Pappas, and Douglas A. Wicks, 2007, Wiley—Interscience; and “BASF Handbook on Basics of Coating Technology”, Artur Goldschmidt and Hans-Joachim Streitberger, 2003, Vincentz Network.

According to an embodiment of the invention, a method is provided for providing or integrating photocatalytically active material into paint, while limiting, reducing or avoiding undesired activity of the photocatalyst, such as oxidation of the binder, e.g. film breakdown, when exposed to the environment, such as light, including UV-radiation. This can be achieved by coating the photocatalytic material onto micro-sized (carrier) particles, such as particles with an equivalent diameter smaller than e.g. 200 μm; 500 μm; or 1000 μm, instead of mixing the photocatalytic particles directly into the paint. By coating the photocatalyst on (inert) carrier particles the photocatalytic reaction is believed to take place at a surface which is inert, i.e. not oxidized by the reaction, and contact between the photocatalyst and binder is minimized.

According to an embodiment of the invention, the amount of photocatalytic material released from a paint film over time is reduced, compared to paint film, where the photocatalytic material is not bound to carriers/particles. Without wanting to be bound by any theory, it is believed that this can be achieved because the photocatalytic material(s) is/are immobilized on larger particles that are much deeper embedded in the film than e.g. a photocatalytic particle in nano-size would be.

According to an embodiment of the invention, a healthier and/or less toxic paint composition and/or (dried) paint film is provided. Without wanting to be bound by any theory, it is believed that larger particles, such as e.g. >5 micron, do not diffuse into skin as easily as smaller particles, making them much easier to wash off if skin is contaminated.

According to an embodiment, a benefit of using inert particles according to the invention is provided, as carriers after some weathering of a paint film (surface), the concentration of inert material in the surface will be increased giving the overall effect of increased weather stability of the paint film.

According to an embodiment of the invention, the photocatalytic coating can also be a multifunctional coating, providing e.g. (improved) adhesion between the binder and the carrier particles, whereby the overall film becomes more resistant to cracking.

Self-Cleaning Surface

According to a third aspect of the invention, a self-cleaning surface is provided comprising a dried layer (paint film) derived from a self-cleaning paint, such as a self-cleaning paint according to the first aspect of the invention.

According to an embodiment of the invention, a self-cleaning surface is provided on e.g. one or more of wood, brick, concrete, cement, asphalt, natural or artificial stone, clay, glass, plastic, metal, fibre glass, carbon fibres, (wall) paper, painted surface, glued surface, composite material, or any combination thereof, such as a surface on an item, wall, building, structural element, bridge, building element, building block, window, door, floor, ceiling, roof (sheathing), smoothed and/or plastered surface, furniture, house hold equipment, medical equipment, sanitary equipment, car, (motor)bike, truck, container, bus, aircraft, rocket, ship, train, locomotive, wind mill, or solar panel; including any combination thereof.

According to an embodiment of the invention, a similar, constant or near constant ratio can be provided or obtained of paint film surface area (without (coated) micro-sized particles) to surface of coated micro-sized particles (e.g. TiO₂-coated HGMS) through the lifetime of the paint file (painted/coated surface). Thereby, a self-cleaning surface is provided during the lifetime of the painted/coated surface.

Without wanted to be bound by any theory, examples of surface ratios of the environment-exposed surfaces of paint surface (without coated micro-sized particles) and coated micro-sized particle (e.g. TiO₂-coated HGMS) surface may comprise the range of 1:100 to 1:10; 1:10 to 1:1; 1:1 to 10:1; or 10:1 to 100:1. These ratios are determined, assuming a flat and horizontal surface of the paint film (without particles) and a spherical surface of the surface-exposed particles (micro-sized particles) HGMS.

HGMS are used as a common filler material in paints. It is thus believed that such particles are a suitable (micro-sized) particle according to the invention. Different volume percentage of HGMS can be added to paint, approximately up to 40%, which gives a large surface area coated with anatase. In one embodiment of the invention, a paint or paint film comprises 1-50%, 10-45%, 20-40% or 30-40% (volume/volume) HGMS.

According to an embodiment of the invention, a paint system is provided wherein (photocatalytic) degradation of e.g. one or more of binder(s), pigment(s), and/or chemical compound(s)/composition(s) in the paint or paint film is reduced, inhibited, delayed, prevented in the paint/painted surface/coating, by the use of micro-sized particles comprising a photocatalytic coating compared to similar coatings comprising photocatalytic nano-particles instead of micro-sized particles comprising a photocatalytic coating.

According to the invention, a painted surface such as e.g. a paint film is provided with self-cleaning properties, such as the capability of maintaining the painted surface essentially free of organic and/or inorganic dirt, filth, debris and the like, providing e.g. a cleaner appearance. This can reduce or avoid e.g. discoloring/staining of the painted surface. Furthermore, a paint composition providing a self-cleaning painted surface has the potential or capability to reduce growth of on or more of microorganism, bacterium, mould, yeast, alga, lichen and plant. This could e.g. be due to the lack of nutrients, and/or the production of one or more toxic and/or aggressive chemical compound.

According to an embodiment of the invention, the photocatalytic activity of the painted surface/coating is maintained essentially unchanged during the total life span of the painted film (painted surface).

### Method of Cleaning a Surface

According to a second aspect of the invention, a method of cleaning a surface is provided.

According to an embodiment of the invention, such a method for cleaning a surface may comprise exposing a self-cleaning surface, such as a self-cleaning surface according to the 2^{nd} aspect of the invention, to electromagnetic radiation, wherein said electromagnetic radiation comprises radiation with a wavelength in the range of 200-400 nm and/or 400-800 nm, wherein said radiation is provided by the sun (e.g. daylight, reflected sunlight, twilight, moonlight), or by an artificial source.

According to an embodiment of the invention, the method of cleaning a surface comprises irradiation with a wavelength comprising 388 nm or less, and/or a wavelength corresponding to the band-gap of the photocatalyst and/or n-type semiconductor, or a wavelength shorter than the band-gap of the photocatalyst and/or n-type semiconductor.

According to an embodiment of the invention, the paint film inhibits growth of microorganisms, e.g. by killing them on the surface through reaction products derived from the highly oxidative photocatalytic process taking place on the coated beads. It is believed that microorganisms will not be able to survive on the surface of a paint film according to the invention, and thereby said microorganisms are prevented from penetrating the paint film and reaching e.g. a substrate, such as a wood substrate, covered by the paint.

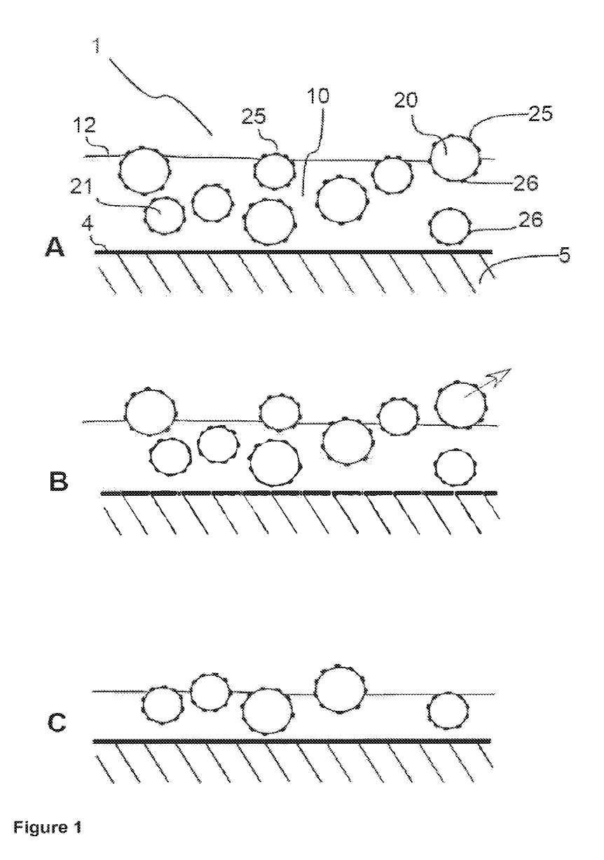

According to one embodiment of the invention, the coated particles comprised in a paint composition and/or paint film are Hollow Glass Micro Spheres (HGMS), e.g. coated/coupled with anatase and/or one or more other compounds and or compositions. An embodiment of a coating/painted surface according to the invention comprising HGMS coated with anatase is illustrated in FIG. 1.

FIG. 1 shows a cross section of a surface or substrate 5 painted/coated with a paint according to the invention. The paint comprises beads, such as hollow glass microspheres (HGMS) 20, 21 which are coated with TiO₂ in the photocatalytic active form of anatase 25, 26. The thickness of the coating/paint 10 deposited on the surface 5 exceeds the diameter of the TiO₂-coated HGMS 20, 21. Upon application of the paint and drying of the paint, a population of TiO₂-coated HGMS will be embedded in the surface, whereby anatase will be exposed to the environment. Other TiO₂-coated HGMS will be covered and/or embedded in a layer of paint. FIG. 1 A shows a newly painted surface. With time, the thickness of a painted layer can decrease (FIG. 1 B), e.g. through one or more of degradation, weathering, erosion, abrasion and the like. Consequently, e.g. after prolonged periods of weathering, TiO₂-coated HGMS close to the surface can become loose and fall of. Such a TiO₂-coated HGMS is illustrated with an arrow. This process can continue as seen in FIG. 1 C, where the thickness of the paint/coating has decreased further, and more TiO₂-coated HGMS have been lost. However, there will still be TiO₂-coated HGMS present protruding the surface, exposing photocatalytically active anatase.

In an embodiment of the invention, all, or a fraction of the anatase-coated HGMS can be covered by the paint composition (without glass beads), e.g. shortly upon providing a paint film. It is believed that during natural decay of the painted/coated surface, e.g. through degradation of the binder, gradually, the coating surface will have a larger percentage of glass in it and therefore the degradation of the paint film should be decreased. Particles, such as beads and/or spherical particles can be added to paint in significant amounts without making the paint too viscous. Consequently, a large fraction or proportion of the surface can comprise beads, such as TiO₂-coated HGMS which are often more weather resistant than the binder, and which also may contribute to providing a self-cleaning surface which does not decompose as a result of e.g. a photocatalytic effect. Dirt from the environment will sit on the glass and be oxidized when subjected to sunlight. The OH radicals created by the photocatalysis are believed to be extremely short lived, half life of approximately 10⁻⁹s. It is assumed that OH radicals will decay before they can reach/diffuse to the binder.

According to an embodiment of the invention, anatase on the side of the HGMS that is embedded and/or in contact with the paint/film, i.e. non-surface-exposed anatase, will not be active or show reduced activity, e.g. due to lower levels of (UV-)light or reduced availability of water molecules. This can inhibit, prevent or reduce the formation of radicals, thereby preventing and/or reducing degradation of the paint/film.

Without being bound by a single theory, it is believed that anatase-catalyzed photochemical reaction(s) will occur, whereby OH-radicals and/or peroxy-radicals are formed from e.g. water and/or oxygen. These radicals are believed to be highly reactive, and to possess a very short life span. Due to the short life span of the radicals, it is assumed that they are unlikely to move away from the site of creation, e.g. by diffusion. Consequently, the highly reactive radicals that otherwise would be very damaging for e.g. a filler or pigment present in a paint, will remain close to the site of creation. These radicals will be created where anatase absorbs light, such as UV light, in the presence of water at the surface of a painted/coated surface according to the invention.

By the use of TiO₂ in the catalytic active form of anatase coupled to particles, such as HGMS, the location of the anatase crystals is confined to the exterior of the particles, to which they are bound/coupled/attached to. Thereby, occurrence of unbound anatase crystals in the paint is avoided. The presence of unbound anatase crystals in the paint is not desired, as it is believed that their presence has a negative influence on essential components of the paint, such as binder, pigment and/or additives.

When particles, such as HGMS, are mixed into a coating composition, such as paint, it is typically done by high shear mechanical blending. It is therefore vital that the anatase coating is strongly bound to the particles, i.e. covalently bound, to avoid anatase particles being released from the carrier particles during mixing.

According to an embodiment of the invention, a surface comprising particles (e.g. glass) and photocatalytic/functional layer/composition (e.g. anatase) is provided, where the light-induced catalytic property of the photocatalytic/functional layer/composition (e.g. anatase) is physically separated/spaced from e.g. the binder, pigment and/or additive. This system is believed to be active for an extended period of time.

It is also believed that the lifetime of a coated/painted surface provided with a paint according to the present invention is significantly longer compared to a paint comprising e.g. anatase dispersed in the paint, i.e. non-coupled/conjugated/attached to particles, such as HGMS.

### Use of a Self-Cleaning Coating Composition

A fourth aspect of the invention concerns the use of a self-cleaning coating composition, such as a self-cleaning coating composition (paint) according the first aspect of the invention for providing a self cleaning surface, such as a self cleaning surface according to the second aspect of the invention.

According to an embodiment of the invention, a self-cleaning coating composition (paint) is used for providing a self-cleaning surface e.g. on one or more of wood, brick, concrete, cement, asphalt, natural or artificial stone, clay, glass, plastic, metal, fibre glass, carbon fibres, (wall) paper, painted surface, glued surface, composite material, or any combination thereof, such as a surface on an item, wall, building, structural element, bridge, building element, building block, window, door, floor, ceiling, roof (sheathing), smoothed and/or plastered surface, furniture, house hold equipment, medical equipment, sanitary equipment, car, (motor)bike, truck, container, bus, aircraft, rocket, ship, train, locomotive, wind mill, or solar panel, including any combination thereof.

Micro-Sized Particles Coated with a Functional Layer

In a fifth aspect, the present invention pertains to micro-sized particles coated with a functional layer, such as any micro-sized particle(s) according to the first aspect of the invention.

According to an embodiment of the invention, micro-sized particles comprise one or more of hollow beads, partially hollow beads, solid beads, or any combination/ratio of hollow-, partially hollow, and solid beads, wherein the beads comprise e.g. one or more material(s) selected from ceramic material(s); polymeric material(s); cermet material(s); metallic material(s); pigmented material(s); light-absorbing and/or light reflecting material(s); including any combination thereof.

According to an embodiment of the invention, beads are coloured/pigmented to match the desired color of the paint film. This can be achieved by adding pigment to the bead material or by coating the beads with a material which yields the desired color before coating the beads with the photocatalytic material. The pigments may include inorganic and/or organic pigments e.g. phtalo blue, phtalo green, chinacridone, naphthol and azo. According to an embodiment of the invention, a paint, coating, or composition comprises one or more organic and/or inorganic pigment(s) disclosed in disclosed in Industrial Inorganic Pigments, 3rd, Completely Revised and Extended Edition, Gunter Buxbaum and Gerhard Pfaff (Editors), ISBN: 978-3-527-30363-2 (2005); and/or Industrial Organic Pigments: Production, Properties, Applications, 3rd, Completely Revised Edition Willy Herbst, Klaus Hunger, ISBN: 978-3-527-30576-6 (2004).

According to an embodiment of the invention, a paint or paint film comprises a mixture of micro-sized particles coated with a functional layer to non-coated micro-sized particles (e.g. TiO₂-coated HGMS to TiO₂-coated HGMS) of less than 1:100, 1:100-1:10; 1:10-1:1; 1:1-10:1; 10:1-100:1, or more than 100:1.

According to an embodiment of the invention, carrier particles, such as micro-sized particles according to the invention, can be fully or partially coated with one or more photocatalytic materials. This may comprise any combination of photocatalytic materials that e.g. under illumination and in the presence of air are capable of accelerating oxidation of one or more organic compounds. Photocatalytic materials may comprise, but are not limited to one or more of: TiO₂, ZnO, WO₃, SnO₂, MOO3, CaTiO3, Bi₂S₃, Cu₂O, Fe₂O₃, ZrO₂, SiC and TiₓZr₍₁₋ₓ₎O₂ (where x is a number between 0 and 1); including any combination thereof.

It is believed that doping the surface and/or bulk of a photocatalyst with one more elements, such as metals, can increase, alter, or reduce the efficiency or the working range (e.g. nm) of a photocatalyst according to the invention.

In one embodiment of the invention the coated beads are doped, preferably on the surface instead of in the bulk, with co-catalysts able to accelerate the oxidation process that yields self cleaning properties. Said co-catalysts include any one or a combination of palladium, platinum, rhodium, ruthenium, tungsten, molybdenum, gold, silver, copper and oxides or sulphides thereof, preferably in amounts of 0.001; 0.01; 0.1-1; 2; 5 weight % of the photocatalyst.

According to an embodiment of the invention, the beads comprise one or more metallic materials. The term metal may be used for both pure metals and alloys.

According to an embodiment of the invention, the beads comprise one or more cermet materials. The term cermet may be used for materials which are composites of metals and ceramics.

According to an embodiment of the invention, the beads are believed to be acting at least in part as a waveguide, and internally reflect light, such as sunlight back to the photocatalytic coating. The beads can be hollow and may possess an index of refraction e.g. between 1.4-1.6; 1.2-1.6; 1.4-2.0; or 2.0-2.7. The photocatalytic coating material can have an index of refraction of e.g. 2.5-2.75; 2.0-4.0; 2.0-3.0 or 1.5-3.0. Without wanting to be bound by any theory, it is believed that in the case the beads are hollow; it could be beneficial, if the photocatalytic coating material has a substantially higher index of refraction than the bead. When e.g. sunlight hits a coating, which has a much higher index of refraction than air, the light is refracted and according to Snell's law, it will have a low angle of refraction compared to the angle of incidence, which in essence guides the sunlight closer to the centre of the bead. When the sunlight is again refracted in the bead material the angle of refraction is increased. When light passes from a material with a high index of refraction to one with a lower index of refraction there is a critical angle, calculated from the indices of refraction of the two materials, where all the light is reflected. This phenomenon is also called total internal reflection. When the sunlight hits the air in the hollow space of the bead a substantial fraction can be totally reflected back up to the photocatalytic coating. This means that less sunlight will pass through the bead. This can be advantageous, because due to (total) internal reflection, more light can be absorbed in the photocatalytic coating at the surface of the paint film, thereby increasing the yield of the self cleaning effect. Furthermore, it is believed that (total) internal reflection may contribute to reducing potential damage to the paint film, due to reduction of light-induced activation of the photocatalytic material comprised and/or enclosed in the paint film (i.e. not exposed to the surface).

According to an embodiment of the invention, the beads are pigmented to match the desired color of the paint film. This can be done to avoid discoloring of the film, e.g. when the beads become exposed on the surface of the paint film. Even though the beads are so small that they are nearly not visible to the human eye, it is believed that a large concentration of beads in the surface can affect the optical properties. For example white beads in a dark colored paint film could have a “bleaching” effect because of the countless small white dots in the surface of the film.

According to an embodiment, hollow or solid beads according to the invention comprise, consist of, or consist essentially of one or more ceramic material(s), such as glass, borosilicate glass. The beads can be, and may be coated with a photocatalytic material. According to another embodiment, said beads comprise, consist of, or consist essentially of one or more polymeric material(s), such as e.g. a tough and ductile organic polymer or silicone. According to a further embodiment, if necessary, e.g. in order to protect the polymer from a (photo)catalytic action of the photocatalytic layer, the beads are provided with a protective and/or intermediate layer of a suitable material that is not oxidized by e.g. a (photo)catalytic reaction, such as for example materials like SiO₂ or Al₂O₃.

According to an embodiment of the invention, the binding strength of the bound photocatalytic layer, such as bound anatase crystals, is so high that the amount of loose photocatalytic layer (e.g. anatase crystals) after sonicating the coated beads for half an hour in distilled water is less than 10, 5, 2, 1, 0.5, or 0.1% of the total weight of the coated beads.

In an embodiment of the invention, the coated beads improve the abrasion resistance of the paint film.

In an embodiment of the invention, the coated beads improve the weather resistance of the paint film.

In one embodiment of the invention, the coated beads improve the UV stability of the paint film by acting as UV-stabilizers.

### Providing Micro-Sized Particles

A sixth aspect of the present invention concerns one or more methods for providing micro-sized particles, such as micro-sized particles according to the first and/or fifth aspect of the invention.

According to an embodiment of the invention, photocatalytic material is e.g. covalently bonded to the beads, whereby release of nano-sized photocatalytic particles to the environment or paint composition is reduced or avoided. Suitable coating processes may comprise e.g. Physical Vapour Deposition (PVD), Plasma Enhanced Physical Vapour Deposition (PE-PVD), Chemical Vapour Deposition (CVD), Plasma Enhanced Chemical Vapour Deposition (PE-CVD), Metal Organic Chemical Vapour Deposition (MO-CVD), Atomic Layer Deposition (ALD) and/or “wet chemistry” using a metal-organic precursor, such as e.g. a metal-alkoxide dissolved in alcohol. According to a further embodiment of the invention, a material, such as a catalytically active material according to the invention, is deposited on a bead and/or particle, such as a glass bead, using a method or principle disclosed in “Handbook of Physical Vapor Deposition (PVD) Processing” Donald M. Mattox, 1998, Noyes Publications, and/or “Principles of Chemical Vapor Deposition” Daniel M. Dobkin and Michael K. Zuraw, 2003, Kluwer Academic Publishers; the subject matter of the before-mentioned references is herewith incorporated by reference.

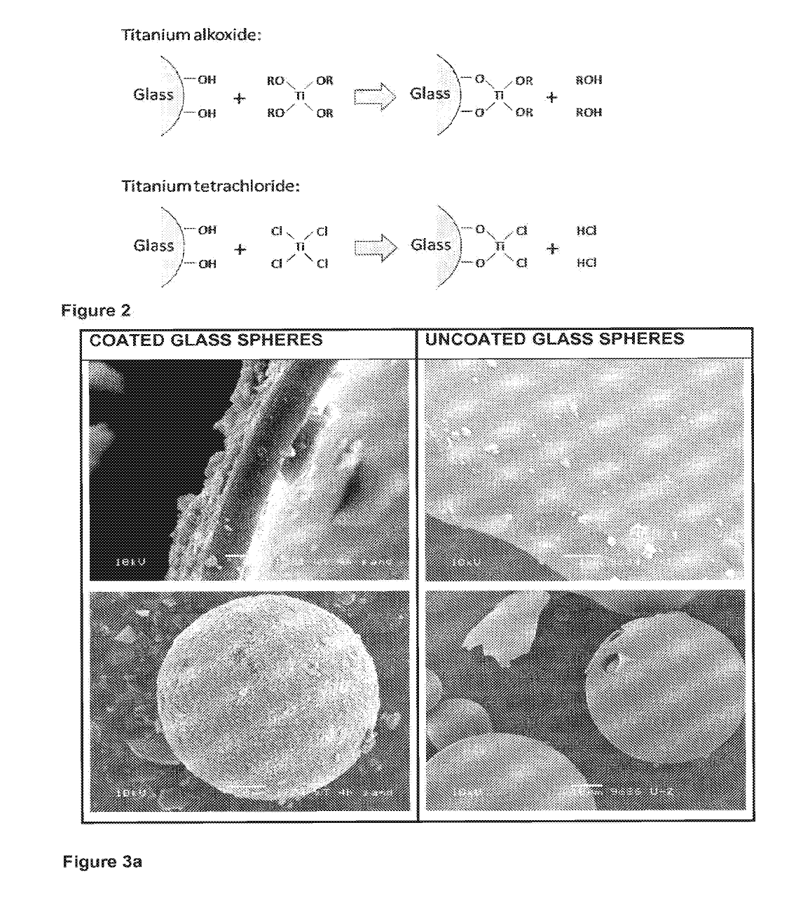

According to an embodiment of the invention, TiO₂-coated and/or anatase-coated (hollow) glass spheres are provided by coating hollow glass microspheres with a CVD process. The titanium precursor used in the process can be an organic-titanate, titanium alkoxide, e.g. titanium-tetraisopropoxide (TTIP), and/or Titanium-tetrachloride (TiCl₄). To achieve covalent bonding between the glass surface and the anatase TiO₂ coating, it is believed that the titanium precursor must be easily hydrolyzed. It is believed that the reaction comprises that OH groups on the glass surface hydrolyze the titanium precursor, whereby a covalent bond between the glass surface and the titanium atom is provided (see FIG. 2). The process can e.g. be divided into the following steps (at atmospheric pressure):
1. The hollow glass microspheres are pre-treated by heating them to 110-200° C. to evaporate physically adsorbed water of the surface.
2. The titanium precursor is evaporated by applying heat and/or vacuum.
3. Inert gas, e.g. nitrogen, argon etc., e.g. with less than 10 ppm H₂O is used to carry the evaporated precursor into a reaction chamber, where the hollow glass microspheres are continuously being stirred e.g. mechanically or fluidized by the carrier gas. The temperature in the reaction chamber can be in the range −20-800° C.
4. The titanium precursor reacts with the glass surface, when it comes into contact with OH groups on the glass surface, which groups hydrolyze the precursor, creating a covalent between the titanium atom and the glass bead (FIG. 2).
5. Inert gas with 0.01-50% relative humidity is blown through the hollow glass microspheres to hydrate the surface while e.g. stirring or fluidizing.
6. Steps 2 through 5 are repeated to build up a thicker layer.
7. The coated microspheres are heated to temperatures in the range 100-800° C. for a period ranging from a few seconds to several hours to crystallize the anatase.

The following contemplations may comprise considerations of a more theoretical nature, and are not to be construed as limiting to the present invention:

Without wanting to be bound to any theory, it is believed that e.g. the photocatalyst is coated onto beads to minimize contact between the photocatalytic material and the binder of the paint film. If the same volume of coated microspheres or photocatalytic nano-particles are introduced into a paint formulation then clearly the area of contact between the photocatalytic material and the binder is much less in the case of coated microspheres as compared to photocatalytic nano-particles because the nano-particles have a much larger surface area per volume. More importantly when the photocatalytic material is coated on inert material such as micro-sized particles, which protrude from the paint film surface, the photocatalysis, i.e. the self cleaning effect, takes place on an inert surface which is not in contact with the binder material. Due to the size of the microspheres, e.g. UV-radiation will not penetrate deep enough into the paint film to activate the part of the coated microsphere which is within the paint film whereas a nano-particle is so small that if it is at the paint film surface, essentially all its surface area can be activated and therefore all the organic binder adhering the particle to the film can be degraded causing the nano-particle to fall out of the film.

Likewise, it is further contemplated that the coated beads that are located close to the surface, are completely or partially covered with a very thin layer of binder, for example 2 μm or less, upon “painting”, i.e. in a fresh film. The paint film will absorb UV-radiation based on which binder is used and the amount and type of UV-stabilizers used in the paint formulation. Paint formulations generally comprise UV-stabilizers because protecting a substrate from UV-radiation is a typical function of paint. Therefore only the coated beads closest to the surface will become photocatalytically active and affect the thin film covering them. This will cause the thin film covering the beads to loose adhesion and with weathering and wear the thin film will be removed. This will leave a part of the coated beads exposed in the surface of the paint film giving it self cleaning properties. The degradation of the binder, due to the photocatalytic effect, will stop or be severely reduced at this point as the UV-radiation reaching the photocatalytic material is exclusively or predominantly where the binder has been removed. This means the self cleaning effect (photocatalysis) takes place on the inert surface of the bead without contact with the binder. The photocatalytic material that is in contact with the binder is much deeper in the film where very little or no UV-radiation reaches it.

It is also believed that after application of the paint film to a substrate the concentration of coated beads in the surface will increase as the paint film is subjected to wear and/weathering and then remain stable throughout the lifetime of the film as shown in FIG. 1 from a to c. A high concentration of coated beads in the surface of the film will increase the wear and weathering resistance of the film because a bead made of inert material is much more resistant than an organic binder. This will lengthen the service life of the paint film and along with the self cleaning effect make a painted surface maintenance free for a much longer period than a paint film without coated beads.

One benefit of the invention can be that release of photocatalytically active material to the environment is significantly reduced compared to e.g. paint comprising photocatalytic nano-particles. This is not only because the degradation of the paint film is slowed down, because of the positive effect of the coated beads on the wear and weathering resistance of the paint film, but also because the beads are embedded much deeper in the film and therefore much more paint has to be degraded for the beads to be released than for nano-particles. This difference is e.g. illustrated in FIG. 1. Nano-particles have very high activity due to their high surface area and are therefore interesting for this application. There is however not enough known about the effect of nano-particles on the human body but research indicates that photocatalytic nano-particles that come into contact with skin and are exposed to sunlight can be extremely dangerous and possibly carcinogenic. Therefore a paint film comprising a binder degradable by photocatalytic material with highly active photocatalytic nano-particles is a possible health hazard. This is however not the case with this invention because the release of photocatalytic material is by far less and also because the photocatalytic material is prevented from reaching living skin cells below the stratum corneum of the epidermis because it is coated onto much larger particles that do not diffuse as easily through the top skin layers as nano-particles and are therefore much easier to wash off.

### EXAMPLES

The invention is explained more in detail with reference to the below Examples explaining embodiments of the invention, but which are not to be construed as limiting the scope of the present invention as set forth in the appended claims.

### Example 1

This example provided evidence that photocatalytic material such as anatase TiO₂, can be coated onto hollow glass microspheres.

Photocatalytic TiO₂ was coated onto S38 hollow glass microspheres, produced by 3M, with an average/mean size of 40 μm and an average/mean density of 0.38 g/cm³, by treating the microspheres with Vertec XL110, a titanium-tetraisopropoxide (TTIP), produced by Johnson Matthey Catalysts, followed by calcining the product afterwards to crystallize the titanium. The coating procedure was essentially as follows:

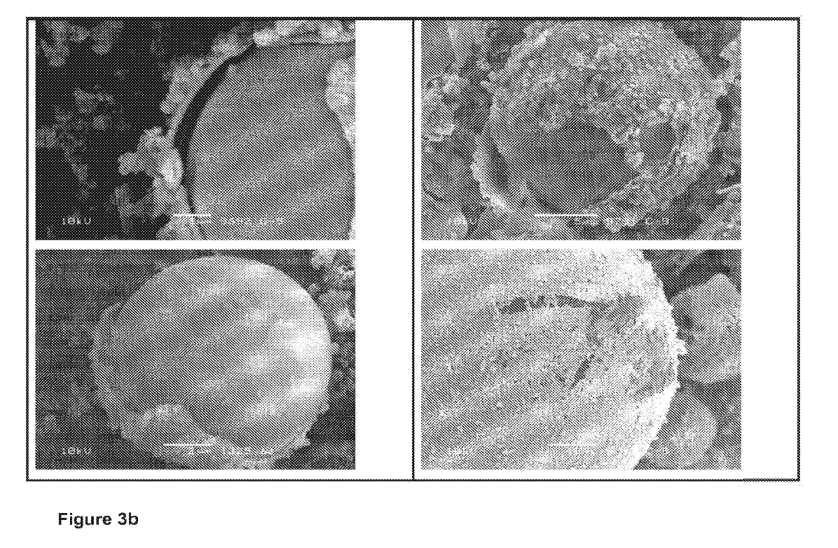

TTIP was dissolved in isopropanol and the ratio of isopropanol to TTIP was 10:1 by volume. After stirring for 20 minutes the S38 hollow glass microspheres were added to the solution in the ratio 1 g glass spheres to 1 ml TTIP and stirred for 20 minutes. Next distilled water was added to the solution in the ratio 1 ml distilled water to 1 g glass spheres and the solution stirred for 10 minutes. The solution was then filtered using a filter paper, such as a Schleicher & Schuell filter nr. 589/1, which retains particles larger than 12 μm, to separate the glass beads from the liquid and afterwards the glass spheres were heated to dryness at 110° C. After all the alcohol had been evaporated the coated glass beads were then heated at 550° C. for 5 hours. The same coating process was then repeated once and then the coated glass spheres were sonicated in distilled water and separated from any anatase powder in the solution. Finally the coated spheres were heated to dryness at 110° C. The photocatalytic coating can be seen in FIG. 3b. However, it was found that the adhesion of the coating was poor and that large shell like pieces would fall off even though no severe mechanical forces had been applied. This is believed to be because of the coating cannot establish a covalent bond with to glass surfaces because physically absorbed water hydrolyzes the TTIP before it can react with surface hydroxyl groups according to the schematic representation of FIG. 2.

### Example 2

This example provided evidence that photocatalytic material such as anatase TiO₂, can be coated onto hollow glass microspheres and that removing physically absorbed water from the glass bead surface gives better adhesion of the coating to the glass bead.

The coating process was performed as in example 1 but the glass beads were pre-treated by heating them to 160° C. for 4 hours and then coated immediately after being removed from the oven. The photocatalytic coating can be seen in FIG. 3a which shows a comparison of a coated and uncoated glass bead.

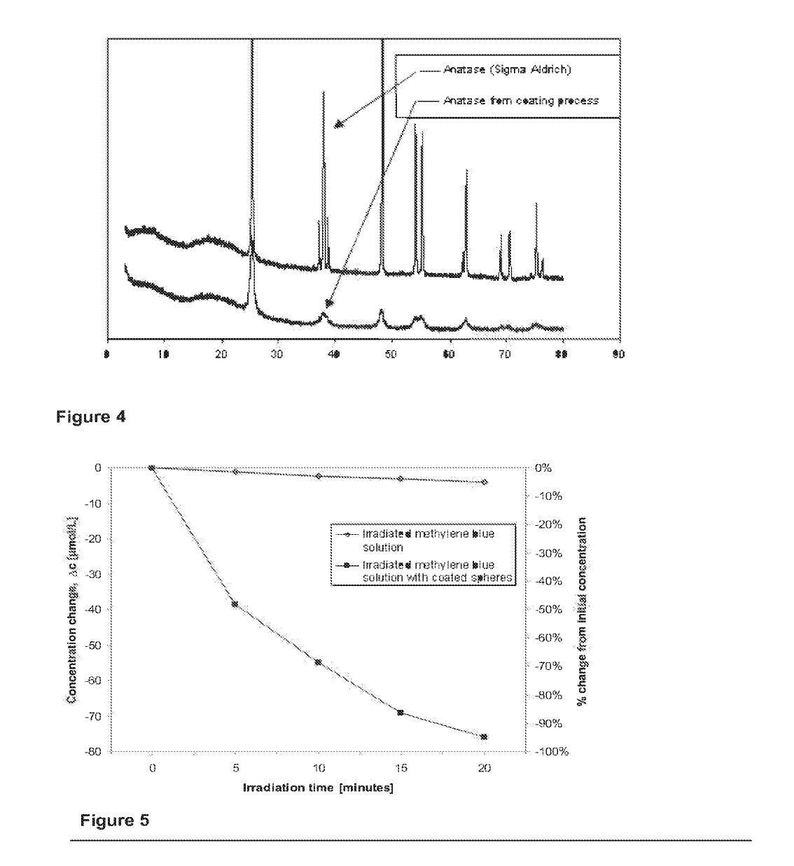

FIG. 4 shows x-ray diffraction patterns, measured with a Huber G670 Guinier diffractometer with a 0.005° measurement step of commercial grade anatase TiO₂ provided from Sigma Aldrich, and anatase from beads coated according to Example 2. The comparison indicated that the coating was essentially anatase because both spectra have peaks at the same angles. The spectrum for the anatase provided from Sigma Aldrich was shifted up in FIG. 4 so both spectra could be clearly seen and compared and both spectra include a tape background which the powder was attached to during the measurement. The high peaks of the commercial grade anatase indicated that the material was highly crystalline and much more than the other spectrum indicated. The wide peaks of the anatase from the coated beads indicated that the crystal size of the material was very small and much smaller than the Sigma Aldrich anatase.

### Example 3

This example provides evidence that hollow glass microspheres coated with anatase TiO₂, as described in Example 2, can accelerate the decomposition/oxidation of an organic material.

The photocatalytic activity of the beads was tested by preparing a dilute solution of an organic dye, methylene blue (MB), and mixing the coated glass beads into the solution. Thereto, 60 mg of coated beads were mixed into 30 ml of dilute MB solution in a 100 ml beaker. After the mix had reached equilibrium in the dark it was exposed for 20 minutes to UV radiation using a Dymax 5000-EC UV lamp where the irradiated area in the 100 ml beaker was around 16.6 cm². The irradiance of the lamp was about 225 mW/cm² and the output wavelength mainly between 350 and 400 nm. The MB concentration was determined by making a calibration curve using a Shimadzu UV-mini 1240 photo spectrometer using an appropriate 1 cm cuvette. The initially determined MB concentration of the mixture was approximately 80 μmol/litre. FIG. 5 summarizes the results of said experiment. After 20 minutes the measured MB concentration had decreased about 76 μmol/litre to 4 μmol/litre, i.e. the blue color of the solution had almost totally disappeared. A MB solution without any glass beads was also irradiated under the same conditions for 20 minutes. The measured concentration change was only 4 μmol/litre which means very little difference could be seen in the solution color showing that the coated beads accelerated the oxidation of MB.

### Example 4

This example provides evidence that a self-cleaning paint film can be provided comprising photocatalytic material, without the film being severely degraded as a result of photocatalytic activity.

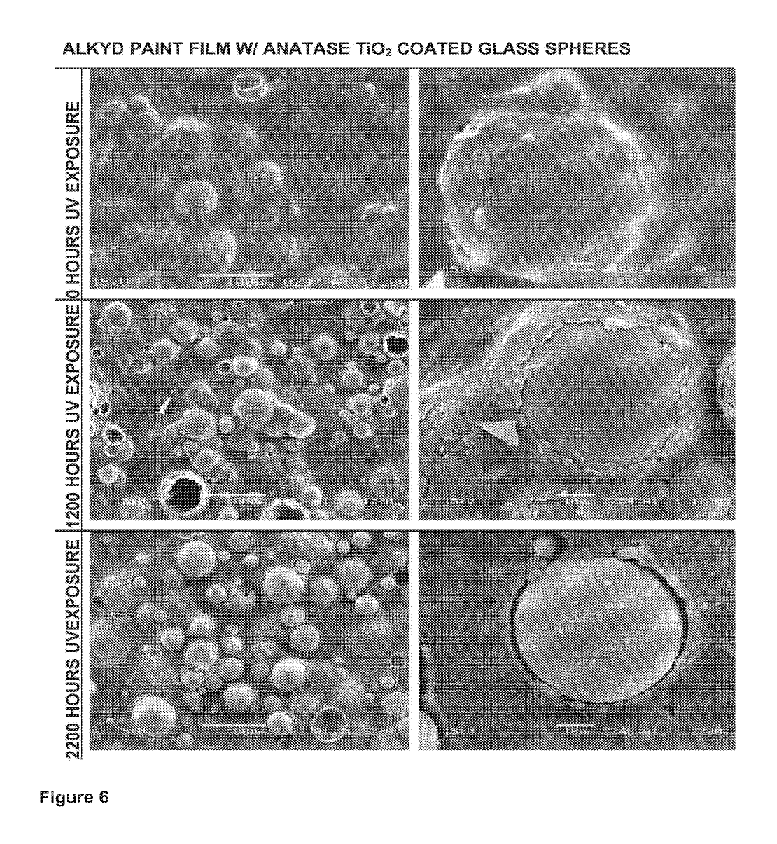

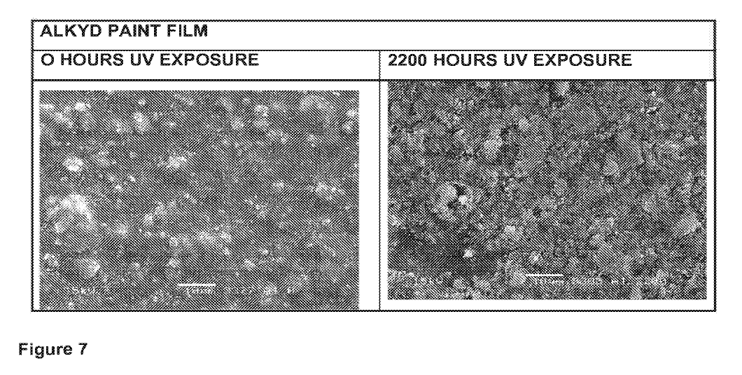

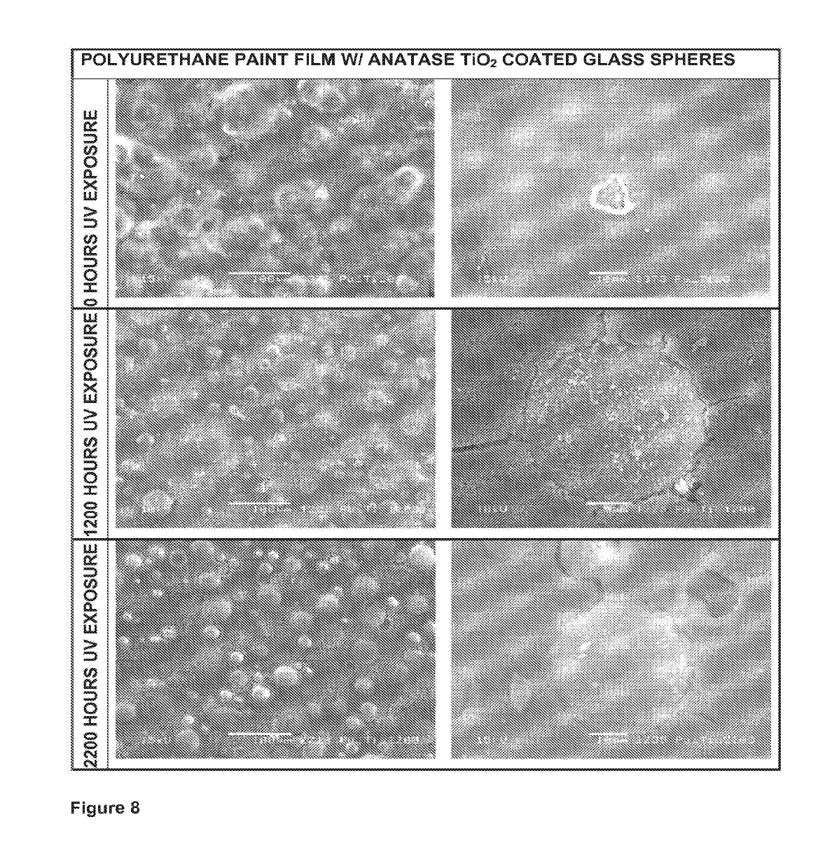

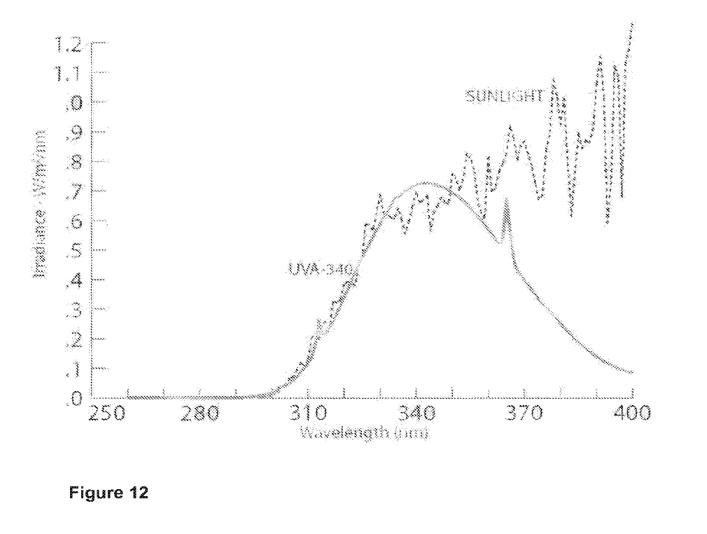

To test the effect of the coated beads on a paint film a typical alkyd paint formulation comprising ˜40% resin, ˜28% coated HGMS, ˜2% pigment, ˜29% solvent and ˜1% additives was prepared, to which coated glass beads prepared according to Example 2 were added to the formulation so that 40% of the volume of solids of a dried paint film was coated glass beads. Several 200 μm thick paint films (wet thickness) were applied on panels and placed into a Q-lab (i.e. an accelerated weathering test chamber), where the films were subjected to cycles of 4 hours of UV-radiation, where the temperature was maintained at 60° C., followed by 4 hours moisture condensation, where the temperature was maintained at 50° C. QUV-A340 UV lamps were used in the QUV chamber and the wavelengths emitted from the UV lamps were in the range of essentially 290-450 nm with the highest intensity at 340 nm. FIG. 12 shoes the emission characteristics of the UVA-340 lamps used in the QUV chamber. The films were analyzed using scanning electron microscopy before and after exposure in the QUV chamber. FIG. 6 shows the alkyd paint with coated glass beads after different exposure times. The images show that before any exposure the coated beads near the surface of the paint film were fully or partially coated with a thin layer of binder. After some exposure the photocatalytic coating on the beads had removed the thin layer of binder on top of the beads so the beads became exposed and available for the self cleaning effect. There was no indication of the binder in between the beads being affected by the photocatalyst and actually it was found that the reference sample (the same alkyd formulation without glass beads), seen in FIG. 7, was further degraded indicating that the coated beads improve the weather resistance of the paint film. After having been exposed for 2200 hours in a QUV chamber, roughly correlating to 5 years outdoor exposure, a thin clearance was seen having formed around many of the coated glass beads as a result of photocatalytic activity but as before the rest of the binder is not affected. This did however not cause the beads to fall out of the film even after a long period of exposure. This shows that the photocatalytic coating is not active where it is deeply embedded in the paint film, presumably because the UV radiation does not penetrate so deep into the paint film.

### Example 5

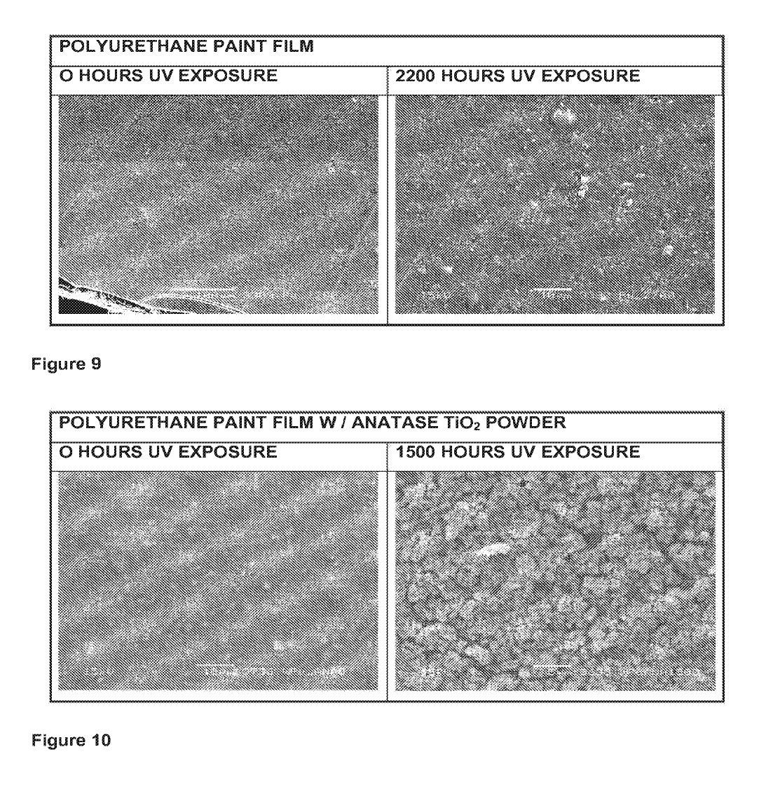

A similar experiment as described in Example 4 was performed with a typical polyurethane formulation, according to table 1, to test the effect of the coated beads on a UV resistant binder. The formulation comprised coated glass beads as 40% of the volume of solids of a dried film. The results of the experiment, shown in FIGS. 8 and 9, were comparable to the results obtained in Example 4. The binder between the beads appeared not affected by the coated beads. Furthermore, the coated glass spheres remained retained/embedded in the paint film even after prolonged exposure to UV radiation.

### Example 6

This example provides evidence that an organic paint with photocatalytic nano-particles is not as durable as an organic paint according to the invention, such as a paint according to Example 4.

A typical polyurethane paint, according to Table 1, comprising nano-sized anatase TiO₂ powder was formulated for comparison. Several 200 μm thick paint films (wet thickness) were applied on panels and put into a QUV test chamber where the films were subjected to cycles of 4 hours of UV-radiation, where the temperature is maintained at 60° C., followed by 4 hours moisture condensation, where the temperature is maintained at 50° C. The wavelengths emitted from the UV lamps in the QUV chamber were in the range of 290-450 nm with the highest intensity at 340 nm. Emission characteristics of the UVA-340 lamps used in the QUV chamber and the wavelengths emitted and the intensity can be seen in FIG. 12.

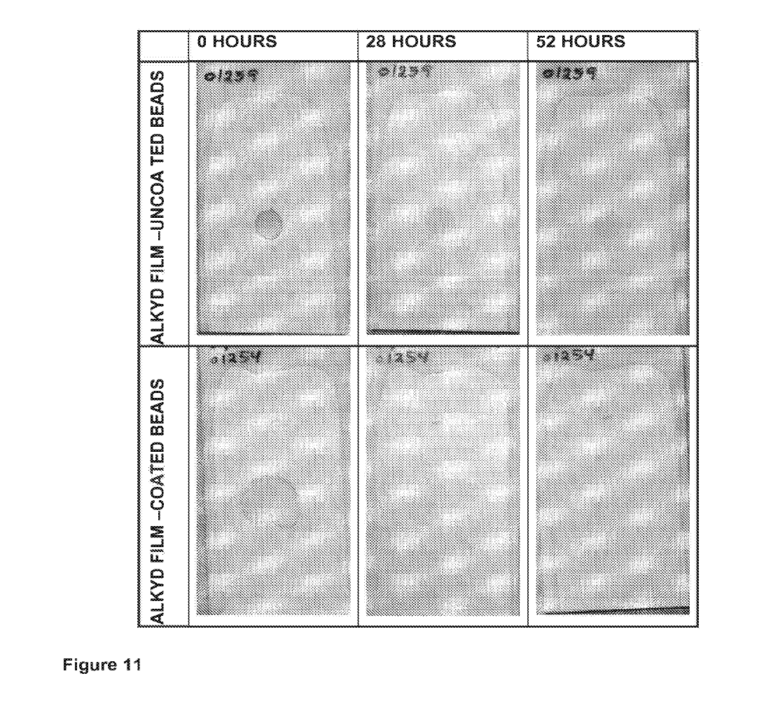

A polyurethane binder was chosen because of its far better UV stability than an alkyd binder. FIG. 10 shows the difference before UV exposure and after 1500 hours exposure. Even though a far more UV resistant binder than alkyd was chosen the film was literally disintegrated after 1500 hours in a QUV chamber and the chalking of the film was so heavy that the surface of the film appeared more as loose fine powder than a solid paint film.

### Example 7

This example provides evidence that a typical alkyd paint film (Table 1), comprising hollow glass microspheres coated with anatase TiO₂, as described in example 2, provides a self cleaning surface.

To test the self cleaning effect of a paint system designed according to the invention, the surface of a typical alkyd paint, comprising coated glass beads according to Example 02, added as 40% of the volume of solids in a dried paint film, and another sample of the same paint, with essentially the same amount of uncoated glass beads, were contaminated with a solution of methylene blue and allowed to dry. The paint panels were then exposed to UV-radiation and humidity in a QUV chamber. The results are shown in FIG. 11. The same amount of methylene blue was applied to both panels, but presumably due to the hydrophilic nature of the TiO₂-coating on the beads, the methylene blue solution was spread over a much larger area on the paint film with coated beads. After only 28 hours of exposure in a QUV chamber the stain on the film with coated beads had almost totally disappeared (FIG. 8). This dearly demonstrates that the coated beads greatly accelerate the decomposition of methylene blue, providing support for the self cleaning effect of the paint film.

### Example 8

This example provides evidence for a method for determining/quantifying the binding strength of a bound photocatalytic layer.

According to an embodiment of the invention, the photocatalytic material coated on the bead material has a high binding strength to the bead to ensure low release of nanoparticles. To test and/or quantify the release of photocatalytic anatase TiO₂ from hollow glass microspheres (HGMS), 10 grams of coated beads provided according to Example 2, are stirred into 250 ml of distilled water in a 250 ml beaker. The beaker is placed in a sonicator, such as a Bronson 1210 sonicator, and the mixture sonicated for a defined period of time, e.g. 40 Hz, such as 30 minutes, using a defined power setting. While the mixture is sonicated it is lightly stirred for 30 seconds every 5 minutes. After sonication, the mixture is centrifuged to separate the coated HGMS and loose anatase powder and the weight of the loose anatase powder and coated HGMS measured.

### Example 9

This example provided evidence of the excellent adhesion properties of coating to glass beads prepared according to example 2.

To test the wear properties of the coating 0.25 g of glass beads coated according to example 2 were mixed into 10 g of quartz sand (average particle size 0.5 mm) in a cylindrical plastic container. The container was fixed to a rotating shaft and the shaft was positioned horizontally. The mixture was rotated for 4 hours and afterwards the sand was separated from the glass beads. The test was so harsh that most glass beads were broken and only very few glass beads survived the treatment. The coating was intact on both the glass beads which survived and the broken pieces as can be seen in FIG. 3a. The glass and coating broke along the same line indicating excellent adhesion because a covalent bond is formed between glass beads and coating.

### LIST OF REFERENCES

Lachheb, Hinda; Puzenat, Eric; Houas, Ammar; Ksibi, Mohamed; Elaloui, Elimame; Guillard, Chantal; Herrmann, Jean-Marie. “Photocatalytic degradation of various types of dyes (Alizarin S, Crocein Orange G, Methyl Red, Congo Red, Methylene Blue) in water by UV-irradiated titania”. Applied Catalysis B: Environmental, Vol. 39, 2002, 75-90.
Linsebigler, Amy L.; Lu, Guangquan; Yates, John T. “Photocatalysis on TiO2 Surfaces: Principles, Mechanisms, and Selected Results”. Chemical Review, Vol. 95, 1995, 735-758.
Portjanskaja, Elina; Krichevskaya, Marina; Preis, Sergei; Kallas, Juha. “Photocatalytic oxidation of humic substances with TiO2-coated glass micro-beads”. Environmental Chemistry Letters, Vol. 2, 2004, 123-127.
Srinivasan, S.; Datye, A. K.; Smith, M. H.; Peden, C. H. F. “Interaction of Titanium Isopropoxide with Surface Hydroxyls on Silica”. Journal of Catalysis, Vol. 145, 1994, 565-573.
BASF Handbook on Basics of Coating Technology, Artur Goldschmidt and Hans-Joachim Streitberger, 2003, Vincentz Network
Coatings Formulation, Bodo Muller and Ulrich Poth, 2006, Vincentz Network Organic Coatings: Science and Technology, 3rd Ed., Zeno W. Wicks, Jr., Frank N. Jones, S. Peter Pappas, and Douglas A. Wicks, 2007, Wiley—Interscience
Industrial Inorganic Pigments, 3rd, Completely Revised and Extended Edition; Gunter Buxbaum and Gerhard Pfaff (Editors); ISBN: 978-3-527-30363-2 (2005)
Industrial Organic Pigments: Production, Properties, Applications, 3rd, Completely Revised Edition; Willy Herbst, Klaus Hunger, ISBN: 978-3-527-30576-6 (2004)
Handbook of Physical Vapor Deposition (PVD) Processing” Donald M. Mattox, Noyes Publications (1998)
Principles of Chemical Vapour Deposition, Daniel M. Dobkin and Michael K. Zuraw, Kluwer Academic Publishers (2003)
Hair, Michael L.; “Hydroxyl Groups on Silica Surface”; Journal of Non-Crystalline Solids, 19, 1975, 299-309.
U.S. Pat. No. 6,110,528 (Agency of Industrial Science and Technology)
JP 2005-199261 (Fujikura Kasei)
WO 2008/142205 (Kemira Pigments OY)
U.S. Pat. No. 5,616,532 (HELLER E & CO)
WO 2004/060555 (PRIZMALITE IND INC)

1. A self-cleaning coating composition comprising a binder and micro-sized particles coated with a photocatalytic layer, wherein the micro-sized particles are hollow or solid beads, or any combination/ratio of hollow and solid beads, wherein the beads comprise one or more material(s) selected from the group consisting of ceramic material(s); polymeric material(s); cermet material(s); metallic material(s); pigmented material(s); light-absorbing and light reflecting material(s); and a combination thereof, wherein said photocatalytic layer is covalently bound to said particles after adsorbed water is evaporated from particle surfaces, wherein the photocatalytic layer comprises TiO₂ in the crystal form of anatase; and wherein the coating composition comprises less than 0.1 percent free anatase particles derived/released from the micro-sized beads, determined as weight/weight of released anatase/total amount of anatase.

2. The self-cleaning coating composition of claim 1, wherein more than 95% of the particles have an equivalent diameter in the range of 0.5-20μ.

3. The self-cleaning coating composition of claim 1 wherein the photocatalytic layer provides one or more of: (a) reduction in growth of organisms selected from: bacteria, algae, lichen, yeasts and/or moulds; (b) increase in adhesion strength between an organic binder and a bead by chemical bonding; (c) increase in abrasion resistance of the paint film; (d) increase in weather resistance and/or UV-stability; (e) decomposition and/or oxidation of undesired organic matter and/or dirt; and (f) improvement of wetting property of the coating composition.

4. The self-cleaning coating composition of claim 1, wherein the photocatalytic layer comprises one or more of: (a) a photocatalyst and/or n-type semiconductor having a band gap in the range of 3.1-4.1 eV; (b) a photoconductive material/composition; and (c) a photocatalytic material/composition; optionally comprising one or more catalyst(s) selected from the group consisting of: TiO₂, ZnO, WO₃, SnO₂, CaTiO₃, Bi₂S₃, Cu₂O, Fe₂O₃, ZrO₂, SiC and TiₓZr₍ᵢ₋ₓ₎O₂ (O<x<1), and any combination thereof; optionally doped with one or more co-catalyst(s), wherein the co-catalyst is selected from the group consisting of palladium, platinum, rhodium, ruthenium, tungsten, molybdenum, gold, silver, copper, including any of their oxides and/or any of their sulfides, and any combination/mixture/ratio of two or more of palladium, platinum, rhodium, ruthenium, tungsten, molybdenum, gold, silver, copper, including any of their oxides and/or any of their sulfides; wherein the molar ratio of co-catalyst(s) to catalyst is less than 3%.

5. The self-cleaning coating composition of claim 4, wherein the photocatalytic layer comprises a photocatalyst and/or n-type semiconductor, and the photocatalyst and/or n-type semiconductor has a band gap of around −3.2 eV (−388 nm), and/or wherein the photocatalyst and/or n-type semiconductor is doped with one or more of N-, S-, and F-atoms, including any combination and/or ratio thereof.

6. The self-cleaning coating composition of claim 4, wherein the photocatalytic layer comprises a photocatalytic material that is covalently bound to said beads/particle; wherein the photocatalytic material coated on the beads has a crystal size of 1-150 nm; and wherein the photocatalytic material coated on the beads has a specific surface area in the range of 0.01-100 m²/g.

7. The self-cleaning coating composition of claim 1, wherein more than 99% by weight of the TiO₂ in the photocatalytic layer is in the catalytic active form of anatase.

8. The self-cleaning coating composition of claim 1, wherein the coating composition is alkyd-, acryl-, polyurethane-, epoxy-, and/or co-polymer-based.

9. A self-cleaning surface comprising a dried layer derived from a self-cleaning coating composition according to claim 1.

10. A method of cleaning a surface, comprising the step of exposing the self-cleaning surface of claim 9 to electromagnetic radiation, wherein said electromagnetic radiation comprises radiation with a wavelength in the range of 200-400 nm and/or 400-800 nm, wherein said radiation is provided by the sun or by an artificial source.

11. The method of claim 10, wherein said wavelength comprises 388 nm or less, and/or a wavelength corresponding to the band-gap of the photocatalyst and/or n-type semiconductor, or a wavelength shorter than the band-gap of the photocatalyst and/or n-type semiconductor.
